(19) United States
(12) Patent Application Publication
(10) Pub. No.: US 2025/0330265 A1
(43) Pub. Date: Oct. 23, 2025

(54) TECHNIQUES FOR JOINT PROBABILISTIC SHAPING OF MULTIPLE BITS PER MODULATION CONSTELLATION

(71) Applicant: QUALCOMM Incorporated, San Diego, CA (US)

(72) Inventors: Wei YANG, San Diego, CA (US); Jing JIANG, San Diego, CA (US); Liangming WU, Beijing (CN)

(21) Appl. No.: 18/865,598

(22) PCT Filed: Jul. 15, 2022
(86) PCT No.: PCT/CN2022/105879

§ 371 Date: Nov. 13, 2024

(51) Int. Cl. H04L 1/00

(52) U.S. Cl. CPC H04L 1/0042; H04L 1/0047; H04L 1/0057

(57) ABSTRACT

Methods, systems, and devices for wireless communications are described that provide for a probabilistic shaping framework for higher-order modulations in which probabilistic shaping of modulation constellations is performed for two or more bits per constellation. A transmitting device may shape a set of information bits using a set of masking bits. The transmitting device may encode, shape, modulate, and transmit the set of information bits to a receiving device, and the receiving device may demodulate, deshape, and decode the received information bits. The transmitting device may transmit a set of shaping bits, which may be indicative of the set of masking bits. The receiving device may use the set of shaping bits to generate the set of masking bits, and may use the set of masking bits to deshape the information bits. Further, the transmitting device may provide an indication of a quantity of shaped bits per modulation symbol.

### CROSS REFERENCE

The present application is a 371 national stage filing of International PCT Application No. PCT/CN2022/105879 by YANG et al. entitled “TECHNIQUES FOR JOINT PROBABILISTIC SHAPING OF MULTIPLE BITS PER MODULATION CONSTELLATION,” filed Jul. 15, 2022, which is assigned to the assignee hereof, and which is expressly incorporated by reference in its entirety herein.

### FIELD OF TECHNOLOGY

The following relates to wireless communications, including techniques for joint probabilistic shaping of multiple bits per modulation constellation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless systems, data may be transmitted to a receiving device by modulating the data into a constellation of modulated symbols. The data may be modulated based on bit values of a number of bits of data that are transmitted in each modulation symbol (e.g., 4 bits in a 16 quadrature amplitude multiplexing (QAM) symbol, 8 bits in a 256-QAM symbol, etc.), and each point in a constellation may have an equal likelihood of use. Enhanced techniques for modulating data into a constellation of modulation symbols may help to enhance the efficiency and reliability of some wireless systems.

### SUMMARY

The described techniques relate to improved methods, systems, devices, and apparatuses that support techniques for joint probabilistic shaping of multiple bits per modulation constellation. For example, the described techniques provide for a probabilistic shaping framework for higher-order modulations in which probabilistic shaping of modulation constellations is performed for two or more bits per constellation. In some cases, a transmitting device (e.g., network entity, user equipment (UE)) may shape a set of information bits (e.g., a set of data bits) using a set of masking bits. The transmitting device may encode, shape, modulate, and transmit the set of information bits to a receiving device (e.g., UE, network entity), and the receiving device may demodulate, deshape, and decode the received information bits. In some cases, the transmitting device may transmit a set of shaping bits, which may be indicative of the set of masking bits used to shape the information bits. The receiving device may use the set of shaping bits to generate the set of masking bits, and may use the set of masking bits to deshape the received information bits. Further, the transmitting device may provide an indication of a number of shaped bits.

A method for wireless communication at a transmitting device is described. The method may include identifying a set of information bits that are to be transmitted to a receiving device, identifying a sequence of signals based on a modulation function between the set of information bits and a set of modulation symbols, generating, based on the sequence of signals, a shaping bit sequence, where the shaping bit sequence is generated from a decoder of a code applied to the sequence of signals, generating a set of probabilistically shaped modulation symbols based on the set of information bits and the shaping bit sequence, where probabilistic shaping is applied for two or more bits of the set of information bits that are transmitted via the set of probabilistically shaped modulation symbols, and transmitting the set of information bits to the receiving device using the set of probabilistically shaped modulation symbols.

An apparatus for wireless communication at a transmitting device is described. The apparatus may include a processor, memory coupled with the processor, and instructions stored in the memory. The instructions may be executable by the processor to cause the apparatus to identify a set of information bits that are to be transmitted to a receiving device, identify a sequence of signals based on a modulation function between the set of information bits and a set of modulation symbols, generate, based on the sequence of signals, a shaping bit sequence, where the shaping bit sequence is generated from a decoder of a code applied to the sequence of signals, generate a set of probabilistically shaped modulation symbols based on the set of information bits and the shaping bit sequence, where probabilistic shaping is applied for two or more bits of the set of information bits that are transmitted via the set of probabilistically shaped modulation symbols, and transmit the set of information bits to the receiving device using the set of probabilistically shaped modulation symbols.

Another apparatus for wireless communication at a transmitting device is described. The apparatus may include means for identifying a set of information bits that are to be transmitted to a receiving device, means for identifying a sequence of signals based on a modulation function between the set of information bits and a set of modulation symbols, means for generating, based on the sequence of signals, a shaping bit sequence, where the shaping bit sequence is generated from a decoder of a code applied to the sequence of signals, means for generating a set of probabilistically shaped modulation symbols based on the set of information bits and the shaping bit sequence, where probabilistic shaping is applied for two or more bits of the set of information bits that are transmitted via the set of probabilistically shaped modulation symbols, and means for transmitting the set of information bits to the receiving device using the set of probabilistically shaped modulation symbols.

A non-transitory computer-readable medium storing code for wireless communication at a transmitting device is described. The code may include instructions executable by a processor to identify a set of information bits that are to be transmitted to a receiving device, identify a sequence of signals based on a modulation function between the set of information bits and a set of modulation symbols, generate, based on the sequence of signals, a shaping bit sequence, where the shaping bit sequence is generated from a decoder of a code applied to the sequence of signals, generate a set of probabilistically shaped modulation symbols based on the set of information bits and the shaping bit sequence, where probabilistic shaping is applied for two or more bits of the set of information bits that are transmitted via the set of probabilistically shaped modulation symbols, and transmit the set of information bits to the receiving device using the set of probabilistically shaped modulation symbols.

In some examples of the method, apparatuses, and non-transitory computer-readable medium described herein, the sequence of signals may be a sequence of real numbers that correspond to a sequence of terms of a mapping function between the set of information bits and the set of modulation symbols. In some examples of the method, apparatuses, and non-transitory computer-readable medium described herein, the code applied to the sequence of signals may be a concatenated code including an inner code and an outer code.

Some examples of the method, apparatuses, and non-transitory computer-readable medium described herein may further include operations, features, means, or instructions for determining a set of masking bits based on a matrix associated with the inner code that is applied to the shaping bit sequence. In some examples of the method, apparatuses, and non-transitory computer-readable medium described herein, the generating the set of probabilistically shaped modulation symbols may include operations, features, means, or instructions for combining the set of masking bits with the set of information bits. In some examples of the method, apparatuses, and non-transitory computer-readable medium described herein, the shaping bit sequence may be generated from decoding the outer code to convert the sequence of signals having a first length into a second sequence of signals of a second length, and decoding the inner code to convert the second sequence of signals of the second length into the shaping bit sequence and the first length and the second length is associated with a quantity of shaped bits per modulation constellation.

In some examples of the method, apparatuses, and non-transitory computer-readable medium described herein, a masking bit sequence may be determined from the shaping bit sequence, the shaping bit sequence may be applied to a subset of the set of information bits to generate the set of probabilistically shaped modulation symbols, and the masking bit sequence may have the second length. Some examples of the method, apparatuses, and non-transitory computer-readable medium described herein may further include operations, features, means, or instructions for transmitting the shaping bit sequence to the receiving device with the set of information bits.

In some examples of the method, apparatuses, and non-transitory computer-readable medium described herein, the generating the shaping bit sequence may include operations, features, means, or instructions for generating a set of intermediate log likelihood ratios (LLRs) from the sequence of signals based on an outer code and decoding the set of intermediate LLRs based on an inner code to generate the shaping bit sequence.

Some examples of the method, apparatuses, and non-transitory computer-readable medium described herein may further include operations, features, means, or instructions for generating a masking bit sequence from the shaping bit sequence and interleaving the masking bit sequence to generate an interleaved masking bit sequence that is applied to the set of information bits. In some examples of the method, apparatuses, and non-transitory computer-readable medium described herein, the interleaving may be performed using a triangle interleaver when a polar code is used to generate the shaping bit sequence. In some examples of the method, apparatuses, and non-transitory computer-readable medium described herein, the interleaving may be performed using a systematic bit priority mapping (SBPM) interleaver when a low density parity code (LDPC) is used to generate the shaping bit sequence.

Some examples of the method, apparatuses, and non-transitory computer-readable medium described herein may further include operations, features, means, or instructions for transmitting an indication of a quantity of probabilistically shaped bits per modulation symbol to the receiving device. Some examples of the method, apparatuses, and non-transitory computer-readable medium described herein may further include operations, features, means, or instructions for may be a function of a modulation order for communications, may be indicated in a modulation and coding scheme (MCS) table, and or any combinations thereof.

In some examples of the method, apparatuses, and non-transitory computer-readable medium described herein, the set of probabilistically shaped modulation symbols includes a first subset of modulation symbols, and a second subset of modulation symbols and the first subset of modulation symbols includes a first number of bits that are shaped per modulation symbol, and the second subset of modulation symbols includes a second number of bits that are shaped per modulation symbol, and the first number of bits and second number of bits may be different.

A method for wireless communication at a receiving device is described. The method may include receiving, from a transmitting device, a set of probabilistically shaped modulation symbols that are used to transmit a set of information bits, and a shaping bit sequence, where the shaping bit sequence indicates probabilistic shaping that is applied to the set of probabilistically shaped modulation symbols, the probabilistic shaping applied for two or more bits of the set of information bits that are transmitted via the set of probabilistically shaped modulation symbols, determining a set of masking bits based on the shaping bit sequence and a matrix, applying the set of masking bits to the set of probabilistically shaped modulation symbols to generate an encoded set of information bits, and decoding the encoded set of information bits to determine the set of information bits.

An apparatus for wireless communication at a receiving device is described. The apparatus may include a processor, memory coupled with the processor, and instructions stored in the memory. The instructions may be executable by the processor to cause the apparatus to receive, from a transmitting device, a set of probabilistically shaped modulation symbols that are used to transmit a set of information bits, and a shaping bit sequence, where the shaping bit sequence indicates probabilistic shaping that is applied to the set of probabilistically shaped modulation symbols, the probabilistic shaping applied for two or more bits of the set of information bits that are transmitted via the set of probabilistically shaped modulation symbols, determine a set of masking bits based on the shaping bit sequence and a matrix, apply the set of masking bits to the set of probabilistically shaped modulation symbols to generate an encoded set of information bits, and decode the encoded set of information bits to determine the set of information bits.

Another apparatus for wireless communication at a receiving device is described. The apparatus may include means for receiving, from a transmitting device, a set of probabilistically shaped modulation symbols that are used to transmit a set of information bits, and a shaping bit sequence, where the shaping bit sequence indicates probabilistic shaping that is applied to the set of probabilistically shaped modulation symbols, the probabilistic shaping applied for two or more bits of the set of information bits that are transmitted via the set of probabilistically shaped modulation symbols, means for determining a set of masking bits based on the shaping bit sequence and a matrix, means for applying the set of masking bits to the set of probabilistically shaped modulation symbols to generate an encoded set of information bits, and means for decoding the encoded set of information bits to determine the set of information bits.

A non-transitory computer-readable medium storing code for wireless communication at a receiving device is described. The code may include instructions executable by a processor to receive, from a transmitting device, a set of probabilistically shaped modulation symbols that are used to transmit a set of information bits, and a shaping bit sequence, where the shaping bit sequence indicates probabilistic shaping that is applied to the set of probabilistically shaped modulation symbols, the probabilistic shaping applied for two or more bits of the set of information bits that are transmitted via the set of probabilistically shaped modulation symbols, determine a set of masking bits based on the shaping bit sequence and a matrix, apply the set of masking bits to the set of probabilistically shaped modulation symbols to generate an encoded set of information bits, and decode the encoded set of information bits to determine the set of information bits.

In some examples of the method, apparatuses, and non-transitory computer-readable medium described herein, the set of masking bits may be determined as a product of the matrix and the shaping bit sequence. In some examples of the method, apparatuses, and non-transitory computer-readable medium described herein, the shaping bit sequence may be received in a separate set of modulation symbols than the set of probabilistically shaped modulation symbols. In some examples of the method, apparatuses, and non-transitory computer-readable medium described herein, the set of masking bits and the shaping bit sequence each may have an associated length that may be based on a quantity of shaped bits per modulation constellation.

Some examples of the method, apparatuses, and non-transitory computer-readable medium described herein may further include operations, features, means, or instructions for deinterleaving the set of masking bits based on an interleaver associated with communications from the receiving device. In some examples of the method, apparatuses, and non-transitory computer-readable medium described herein, the deinterleaving may be performed using a triangle interleaver when a polar code is used for communications from the receiving device, or using a systematic bit priority mapping (SBPM) interleaver when a low density parity code (LDPC) is used for communications from the receiving device.

Some examples of the method, apparatuses, and non-transitory computer-readable medium described herein may further include operations, features, means, or instructions for receiving an indication of a quantity of probabilistically shaped bits per modulation symbol from the transmitting device.

A method for wireless communication at a transmitting device is described. The method may include identifying a set of information bits that are to be transmitted to a receiving device, identifying a quantity of probabilistically shaped bits per modulation symbol associated with a probabilistic shaping scheme for shaping the set of information bits into a probability distribution of modulated symbols, generating a set of masking bits from the set of information bits, where the masking bits are determined based on the quantity of probabilistically shaped bits per modulation symbol, applying the set of masking bits to the set of information bits to form a set of shaped information bits, and modulating the set of shaped information bits into probabilistically shaped modulated symbols based on the probabilistic shaping scheme.

An apparatus for wireless communication at a transmitting device is described. The apparatus may include a processor, memory coupled with the processor, and instructions stored in the memory. The instructions may be executable by the processor to cause the apparatus to identify a set of information bits that are to be transmitted to a receiving device, identify a quantity of probabilistically shaped bits per modulation symbol associated with a probabilistic shaping scheme for shaping the set of information bits into a probability distribution of modulated symbols, generate a set of masking bits from the set of information bits, where the masking bits are determined based on the quantity of probabilistically shaped bits per modulation symbol, apply the set of masking bits to the set of information bits to form a set of shaped information bits, and modulate the set of shaped information bits into probabilistically shaped modulated symbols based on the probabilistic shaping scheme.

Another apparatus for wireless communication at a transmitting device is described. The apparatus may include means for identifying a set of information bits that are to be transmitted to a receiving device, means for identifying a quantity of probabilistically shaped bits per modulation symbol associated with a probabilistic shaping scheme for shaping the set of information bits into a probability distribution of modulated symbols, means for generating a set of masking bits from the set of information bits, where the masking bits are determined based on the quantity of probabilistically shaped bits per modulation symbol, means for applying the set of masking bits to the set of information bits to form a set of shaped information bits, and means for modulating the set of shaped information bits into probabilistically shaped modulated symbols based on the probabilistic shaping scheme.

A non-transitory computer-readable medium storing code for wireless communication at a transmitting device is described. The code may include instructions executable by a processor to identify a set of information bits that are to be transmitted to a receiving device, identify a quantity of probabilistically shaped bits per modulation symbol associated with a probabilistic shaping scheme for shaping the set of information bits into a probability distribution of modulated symbols, generate a set of masking bits from the set of information bits, where the masking bits are determined based on the quantity of probabilistically shaped bits per modulation symbol, apply the set of masking bits to the set of information bits to form a set of shaped information bits, and modulate the set of shaped information bits into probabilistically shaped modulated symbols based on the probabilistic shaping scheme.

In some examples of the method, apparatuses, and non-transitory computer-readable medium described herein, the generating the set of masking bits may include operations, features, means, or instructions for decoding a sequence of signals associated with the set of information bits based on a code applied to the sequence of signals to generate a shaping bit sequence and generating the set of masking bits based on a matrix that may be applied to the shaping bit sequence.

Some examples of the method, apparatuses, and non-transitory computer-readable medium described herein may further include operations, features, means, or instructions for interleaving the masking bits to generate an interleaved masking bit sequence that is applied to the set of information bits prior to modulating the set of information bits. In some examples of the method, apparatuses, and non-transitory computer-readable medium described herein, the interleaving may be performed using a triangle interleaver when a polar code is applied to the sequence of signals. In some examples of the method, apparatuses, and non-transitory computer-readable medium described herein, the interleaving may be performed using a SBPM interleaver when a LDPC is applied to the sequence of signals. Some examples of the method, apparatuses, and non-transitory computer-readable medium described herein may further include operations, features, means, or instructions for transmitting the probabilistically shaped modulated symbols and the shaping bit sequence to a receiving device.

### BRIEF DESCRIPTION OF THE DRAWINGS

FIG. 1 illustrates an example of a wireless communications system that supports techniques for joint probabilistic shaping of multiple bits per modulation constellation in accordance with one or more aspects of the present disclosure.

FIG. 2 illustrates an example of a wireless communications system that supports techniques for joint probabilistic shaping of multiple bits per modulation constellation in accordance with one or more aspects of the present disclosure.

FIG. 3 illustrates an example of a transmission scheme that supports techniques for joint probabilistic shaping of multiple bits per modulation constellation in accordance with one or more aspects of the present disclosure.

FIG. 4 illustrates an example of a reception scheme that supports techniques for joint probabilistic shaping of multiple bits per modulation constellation in accordance with one or more aspects of the present disclosure.

FIG. 5 illustrates an example of probability distributions for joint probabilistic shaping of multiple bits per modulation constellation in accordance with one or more aspects of the present disclosure.

FIG. 6 illustrates an example of a transmission scheme that supports techniques for joint probabilistic shaping of multiple bits per modulation constellation in accordance with one or more aspects of the present disclosure.

FIG. 7 illustrates an example of a interleaving scheme that supports techniques for joint probabilistic shaping of multiple bits per modulation constellation in accordance with one or more aspects of the present disclosure.

FIGS. 8 and 9 show block diagrams of devices that support techniques for joint probabilistic shaping of multiple bits per modulation constellation in accordance with one or more aspects of the present disclosure.

FIG. 10 shows a block diagram of a communications manager that supports techniques for joint probabilistic shaping of multiple bits per modulation constellation in accordance with one or more aspects of the present disclosure.

FIG. 11 shows a diagram of a system including a UE that supports techniques for joint probabilistic shaping of multiple bits per modulation constellation in accordance with one or more aspects of the present disclosure.

FIG. 12 shows a diagram of a system including a network entity that supports techniques for joint probabilistic shaping of multiple bits per modulation constellation in accordance with one or more aspects of the present disclosure.

FIGS. 13 through 19 show flowcharts illustrating methods that support techniques for joint probabilistic shaping of multiple bits per modulation constellation in accordance with one or more aspects of the present disclosure.

### DETAILED DESCRIPTION

Some wireless communications systems may utilize relatively high order modulation to increase spectral efficiency for wireless transmissions. For example a transmitting device may modulate bits using 16 quadrature amplitude multiplexing (QAM), 64-QAM, 256-QAM, or higher modulation orders. The transmitting device may modulate information (e.g., a stream of data bits) into a constellation of modulated symbols, in which the information may be modulated based on bit values of a number of information bits that are transmitted in each modulation symbol (e.g., 4 bits in a 16-QAM symbol, 8 bits in a 256-QAM symbol, etc.). In some systems, and each point in a constellation may have an equal likelihood of use. Additionally, in some systems, probabilistic shaping techniques (e.g., probabilistic amplitude shaping (PAS)) may be implemented that provide a non-uniform distribution in which certain constellation points have a higher probability of being selected, which may result in a larger amount of mutual information transmission capability compared to uniformly distributed constellations. Thus, such non-uniform distributions may result in higher transmission capacities, higher spectral efficiencies, or general higher communication quality than uniform symbol distributions.

Some shaping strategies (e.g., PAS) may provide for one bit of a modulation constellation with a higher likelihood of having a preferred bit value (e.g., in a 16-QAM constellation, if the second bit of a 4-bit sequence has a higher likelihood of being a 0 the constellation point will be closer to the origin and have a higher spectral efficiency). Thus, techniques for shaping for a single bit can provide more efficient communications. Various aspects discussed herein provide for probabilistic shaping of modulation constellations in which two or more bits of a modulation constellation can be shaped, which may provide additional gains in efficiency and reliability, particularly for higher order constellations (e.g., 256-QAM or higher).

In some cases, to provide shaping for multiple bits of a modulation constellation, a shaping strategy may be used where a transmitting device shapes a set of information bits using a set of masking bits. The masking bits may be determined by taking terms of a mapping function between the information bits and a modulation symbol as a sequence of real numbers, and decoding the sequence of real numbers based on a joint linear code that includes an inner code and an outer code. In accordance with various aspects as discussed herein, the term “inner code” may be used to refer to a code that is used to encode a set of shaping bits to the set of masking bits, and the term “outer code” may be used to refer to a code that connects the set of masking bits with signals generated from the set of information bits and a modulation function. In some cases, an inner code may be an example of a first code and an outer code may be an example of a second code; or the outer code may be an example of a first code and the inner code may be an example of a second code; and the joint linear code may refer to coding using the first code and the second code. The joint linear code may be selected to provide probabilistic shaping for two or more bits. The decoding function provides the masking bits that may then be used to modify the set of information bits to provide a probabilistically shaped modulation constellation. The information bits and the masking bits are transmitted to a receiver, which may decode the information bits based on the indicated masking bits that are provided with the information bits. In some cases, the masking bits may be indicated to the receiver by providing a set of shaping bits that are compressed using a shaping code (e.g., a linear shaping code).

Such shaping techniques may support shaping of multiple bits of a modulation constellation, may align mapping with NR coding systems, and may support selective shaping for different sets of resources. The information bits may be encoded for transmission either before shaping or after shaping, and in either case, the information bits and the set of shaping bits may be encoded using different channel coding schemes. In some cases, the transmitting device may also indicate a number of shaped bits per constellation (e.g., as a function of modulation order, or as an additional parameter in an MCS table). The number of bits per constellation also may be fractional. In such cases, the number of shaped bits per constellation could be different for different modulation symbols in the same transmission (e.g., 1.5 bits means that 50% of the modulation symbols have 2 bits being shaped, and 50% of the modulation symbols have 1 bit being shaped).

Aspects of the disclosure are initially described in the context of wireless communications systems. Aspects of the disclosure are illustrated by and described with reference to a reception scheme and transmission schemes, and exemplary probabilities, that relate to joint probabilistic shaping for wireless signals. Aspects of the disclosure are further illustrated by and described with reference to apparatus diagrams, system diagrams, and flowcharts that relate to techniques for joint probabilistic shaping of multiple bits per modulation constellation.

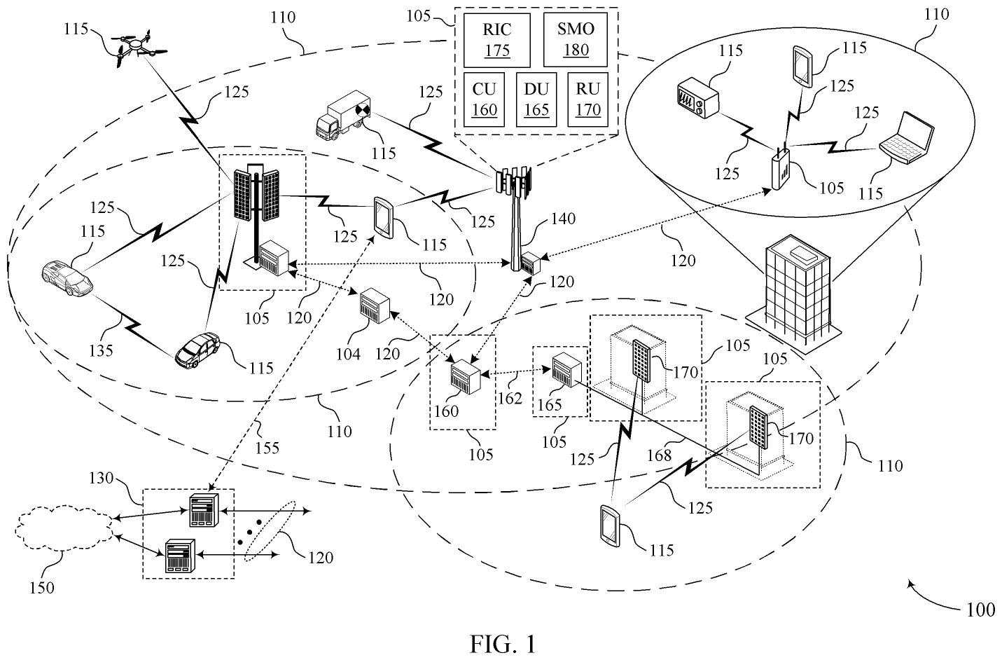

FIG. 1 illustrates an example of a wireless communications system 100 that supports techniques for joint probabilistic shaping of multiple bits per modulation constellation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for joint probabilistic shaping of multiple bits per modulation constellation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, a transmitting device (e.g., a UE 115 or network entity 105) may use probabilistic shaping of modulation constellations in transmissions, where the probabilistic shaping is performed for two or more bits per constellation. In some cases, the transmitting device may shape a set of information bits (e.g., a set of data bits) using a set of masking bits. The transmitting device may encode, shape, modulate, and transmit the set of information bits to a receiving device (e.g., network entity 105, UE 115), and the receiving device may demodulate, deshape, and decode the received information bits. In some cases, the transmitting device may transmit a set of shaping bits, which may be indicative of the set of masking bits used to shape the information bits. The receiving device may use the set of shaping bits to generate the set of masking bits, and may use the set of masking bits to deshape the received information bits. Further, in some cases the transmitting device may provide an indication of a number of shaped bits.

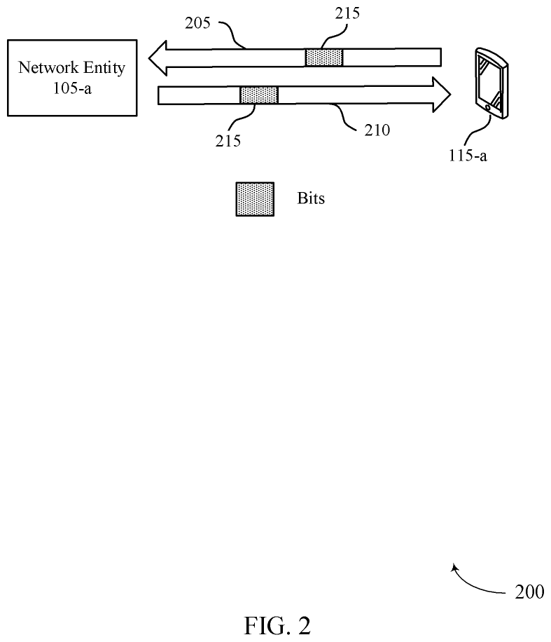

FIG. 2 illustrates an example of a wireless communications system 200 that supports techniques for joint probabilistic shaping of multiple bits per modulation constellation in accordance with one or more aspects of the present disclosure. The wireless communications system 200 may include a network entity 105-a and a UE 115-a, which may be examples of the corresponding devices described herein with reference to FIG. 1. The network entity 105-a and the UE 115-a may communicate with each other in either the uplink or the downlink, where the UE 115-a may transmit in the uplink and the network entity 105-a may transmit in the downlink. In some cases, the UE 115-a may additionally, or alternatively, communicate with another UE 115, such as through sidelink communications. A device transmitting a signal (e.g., in the uplink, downlink, or sidelink) may be referred to as a transmitting device, and a device receiving the transmitted signal (e.g., in the uplink, downlink, or sidelink) may be referred to as a receiving device.

In the example of FIG. 2, the wireless communications system 200 illustrates an example of the network entity 105-a and the UE 115-a communicating via an uplink channel 205 or a downlink channel 210 (e.g., while the UE 115-a may additionally or alternatively communicate with another UE 115 via a sidelink channel). For example, the network entity 105-a, the UE 115-a, or both, may transmit a signal modulated to represent a set of bits 215. As such, the bits 215 (e.g., the modulated signal representative of the bits 215) may be communicated between the network entity 105-a and the UE 115-a via the uplink channel 205 or the downlink channel 210. For example, the data bits 215 may be transmitted via a distribution of modulated symbols, where each symbol in the distribution may represent one or more bits.

Some wireless communications systems (e.g., cellular, Wi-Fi) may utilize higher order modulation (e.g., 16-QAM, 64 QAM, 256 QAM, etc.) to increase spectral efficiency for wireless transmissions at higher signal-to-noise-ratio (SNR) values. In such systems, constellations of unshaped modulated symbols may be fixed (e.g., may be square constellations), where each constellation point (e.g., value, symbol) may have a same probability of being used as another constellation point (e.g., each constellation point may be used with equal probability).

In accordance with various aspects discussed herein, in some cases the distribution of symbols may be shaped such that different symbols may have different probabilities of usage, where such a distribution may be referred to as a non-uniform distribution of symbols or probabilistically shaped symbols. Probabilistic shaping may be used in some cases to increase spectral efficiency of the coded modulation, and may generate non-uniformly distributed coded modulation symbols, or non-uniformly distributed constellations. In some examples, non-uniformly distributed QAM may have a higher capacity than a uniformly distributed QAM. Such non-uniform distributions may result in higher transmission capacities, higher spectral efficiencies, or generally higher communication quality than uniform symbol distributions. For example, non-uniformly distributed constellations may be associated with a larger mutual information (e.g., an information I, defined by parameters X and Y) than uniformly distributed constellations, at the same SNR.

An example of a probabilistic shaping framework may be PAS (e.g., distribution matching). PAS may shape an amplitude of a constellation of modulated symbols (e.g., the amplitude may be non-uniform), while leaving the sign of the constellation uniformly distributed. In some examples, PAS may be performed prior to, or after, channel coding of information bits.

The present disclosure provides techniques for probabilistic shaping of modulation constellations in which two or more bits of a modulation constellation may be shaped. A transmitting device (e.g., network entity 105-a, UE 115-a) may encode, shape, modulate, and transmit information bits to a receiving device (e.g., UE 115-a, network entity 105-a), and the receiving device may demodulate, deshape, and decode the received information bits. In addition to transmitting the information bits to the receiving device, the transmitting device may also transmit a set of shaping bits, which may be indicative of the set of masking bits used to probabilistically shape the information bits. The receiving device may use the set of shaping bits to generate the set of masking bits, and may use the set of masking bits to deshape the received information bits. The information bits may be encoded for transmission either before shaping or after shaping, and in either case, the information bits and the set of shaping bits may be encoded using different channel coding schemes. The shaping bits and the information bits may be separately or jointly modulated for transmission to the receiving device.

In some cases, the transmitting device may shape bits for transmission by generating a masking bit sequence from a shaping bit sequence, and combining the information bits and the masking bit sequence. The shaping bit sequence may also be coded to generate encoded shaping bits. The information bits may be separately encoded from the shaping bit sequence, and both the encoded shaping bit sequence and encoded information bits may be further modulated into one or more constellations (e.g., jointly or separately modulated). The network entity 105-a may transmit the shaped constellation of information bits (e.g., bits 215) and the shaping bit sequence to a receiving device (e.g., UE 115-a, network entity 105-a), such as via a downlink channel 210, an uplink channel 205, or a sidelink channel. In some cases, the transmitting device may indicate a number of shaped bits per modulation constellation. Additionally, or alternatively, the transmitting device may interleave the masking bits to generate an interleaved masking bit sequence that is applied to the information bits.

The receiving device may receive, demodulate, deshape, and decode the shaped constellations received from the transmitting device. The receiving device may first demodulate and decode the shaping bit sequence from received signaling, and use the shaping bit sequence to generate the masking bit sequence. The receiving device may demodulate the shaped information bits and may use the masking bit sequence to deshape, or demask, the information bits. The UE 115-a may decode the information bits from the deshaped information bits, for example, using a channel code (e.g., where the channel code may protect the information payload).

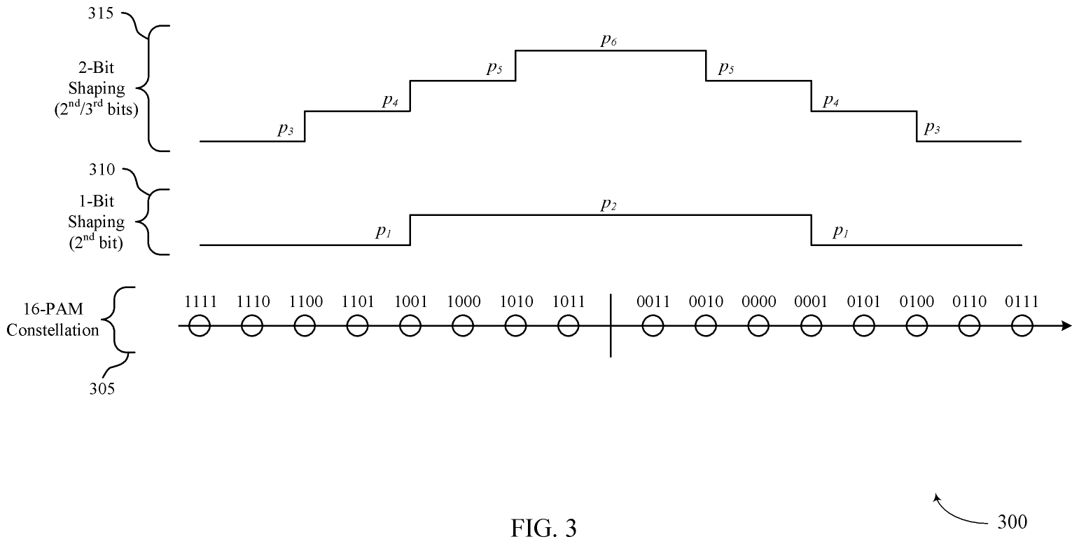

In some existing PAS techniques, single-bit probabilistic shaping may be performed in which one bit of a modulation constellation is shaped. In accordance with various techniques as discussed herein, multi-bit probabilistic shaping may be performed in which two or more bits of a modulation constellation are shaped. FIG. 3 illustrates an example of different numbers of bits that may be probabilistically shaped.

FIG. 3 illustrates examples of probability distributions 300 for joint probabilistic shaping of multiple bits per modulation constellation in accordance with one or more aspects of the present disclosure. The probability distributions 300 may be used by a transmitting device (e.g., a UE 115, a network entity 105), that may modulate and transmit a modulation constellation 305, which may be a probabilistically shaped constellation such as those described herein. The modulation constellation 305 transmitted to the receiving device may be an example of the bits 215 described with reference to FIG. 2.

In the example of FIG. 3, a 16-pulse amplitude modulation (PAM) modulation constellation 305 is illustrated. Examples discussed herein use the convention that one complex constellation point (e.g., 256-QAM) contains two real constellation points/dimensions, corresponding to the real and imaginary part of the same complex constellation point, respectively (e.g., a 256-QAM can be decomposed into two 16-PAM signals/constellation points, and thus a product of a 16-PAM by 16-PAM corresponds to a 256-QAM modulation constellation). In a first example 310, probabilities for different constellation points are illustrated for one shaped bit per modulation constellation. In a second example 315 probabilities for different constellation points are illustrated for two shaped bits per modulation constellation. The number of shaped bits per modulation constellation may refer to the number of bits per real modulation constellation, and corresponding imaginary parts of modulation constellations also may have the number of shaped bits.

In the first example 310, the second bit (e.g., b₁) of four bits per constellation point (e.g., b₀, b₁, b₂, b₃) is probabilistically shaped. Such a bit selection for the shaped bit provides the most impact on the power of the constellation, due to b₁=0 representing all inner constellations (i.e., the eight constellation points closest to the origin), and b₁=1 represents all outer constellation points (i.e., the eight constellation points farthest from the origin). Such single bit shaping provides a first probability (p₁) for the outer constellation points and a higher second probability (p₂) for the inner constellation points. As illustrated in FIG. 3, such a techniques provides a substantial amount of shaping gain by only shaping the bit b₀. For example, if a set of 4 bits [b₀,b₁,b₂,b₃] is mapped to constellation x, the power change δ incurred by flipping the bit b1 may be computed. As an example, if [b₀,b₁,b₂,b₃]=[1110], then letting v=1 (i.e., flipping b₁ from 1 to 0 using b₁+v) moves the constellation point from [1110] to [1010], which yields a power saving as shown in the figure to be 13²−3²=160 (and if v=0, then the power saving is zero). Conversely, if the [b₀,b₁,b₂,b₃]=[1010], then the power saving of flipping b₁ is 3²−13²=−160. Thus, flipping the bit b₁ will increase the power.

A cost function may be defined based on the value of b₁, where the cost function is c([b₀,b₂,b₃])=power([b₀,1,b₂,b₃])−power([b₀,0,b₂,b₃]). Then, a masking sequence V=[v₁, . . . , vₙ] may be determined across n modulation symbols that yield the largest total power saving for a set of information bits. In some cases, V may be selected from a codebook of masking sequences according to:

$${arg max}_{V = [ {v}_{1} , … , {v}_{n} ] ∈ C} {\sum }_{j = 1 , … , n} c ( [ {b}_{0}^{( j )} , {b}_{2}^{( j )} , {b}_{3}^{( j )} ] ) \cdot ( 2 {b}_{1}^{( j )} - 1 ) {v}_{j} = {arg max}_{V = [ {v}_{1} , … , {v}_{n} ] ∈ C} {\sum }_{j = 1 , … , n} c ( [ {b}_{0}^{( j )} , {b}_{2}^{( j )} , {b}_{3}^{( j )} ] ) ( 1 - 2 {b}_{1}^{( j )} ) ( 1 - 2 {v}_{j} ) \qquad Equation ( 1 )$$

In particular, the codebook C may be formed with a linear code according to V=S·G, where S denotes the vector of shaping bits, which is of smaller length than V and G is a generator matrix. It can be shown that this is equivalent to a channel decoding problem, where (1−2vⱼ) is a binary phase-shift keying (BPSK) modulated transmit signal, and

$$c ( [ {b}_{0}^{( j )} , {b}_{2}^{( j )} , {b}_{3}^{( j )} ] ) ( 1 - 2 {b}_{1}^{( j )} )$$

is the received signal. As such, a known channel coding scheme (e.g., polar/low-density parity-check (LDPC) code) can be used to generate a shaping bit sequence S and masking bit sequence V from the signal b.

While shaping one bit per modulation constellation provides enhanced power characteristics for transmitted modulation symbols, for relatively high order constellations or relatively lower communication rate it may be beneficial to provide shaping for two or more bits per modulation constellation. In accordance with various aspects discussed herein, shaping for two or more bits per modulation constellation may be provided through a transmitting device applying masking bits to two or more bits per modulation constellation (e.g., two or more bits per real modulation constellation). For example, in the second example 315 of FIG. 3, two shaped bits per modulation constellation provide four different levels of probabilities, indicated as p₃, p₄, p₅, p₆, for each set of two constellation points from farthest away from the origin to toward the origin, respectively. Such multi-bit shaping thus provides substantial benefits, as shaping gain is further enhanced for constellation points closet to the origin. However, simply extending the one-bit shaping technique discussed above to multiple bits does not yield a power saving function in the form of Equation (1) that could be decoded to generate the shaping bits. That is, is multiple bits were to be shaped at the same time, then the cost function would not have a compact form (as correlations between some real-valued vectors and the shaping bits) as in Equation (1).

In accordance with various techniques discussed herein, generation of sequence of signals (e.g., real valued numbers), that can be used by a decoder to generate masking bits and shaping bits, is provided that allow for decoding to generate two or more masking bits per (real) constellation point. In some cases, the two or more masking bits per constellation point may be generated from a same shaping code. In one example, in the case of a higher order modulation such as 256-QAM modulation, octuplets of bits, b(8i), b(8i+1),b(8i+2),b(8i+3),b(8i+4),b(8i+5),b(8i+6),b(8i+7), are mapped to complex-valued modulation symbols d(i) according to

$$d ( i ) = \frac{1}{\sqrt{170}} \{ ( 1 - 2 b ( 8 i ) ) [ \text{} 8 - ( 1 - 2 b ( 8 i + 2 ) ) [ \text{} 4 - ( 1 - 2 b ( 8 i + 4 ) ) [ 2 - ( 1 - 2 b ( 8 i + 6 ) ) ] ] ] + j ( 1 - 2 b ( 8 i + 1 ) ) [ \text{} 8 - ( 1 - 2 b ( 8 i + 3 ) ) [ 4 - ( 1 - 2 b ( 8 i + 5 ) ) [ 2 - ( 1 - 2 b ( 8 i + 7 ) ) ] ] ] \} .$$

If it is denoted that: 1−2b(8i)=x₀; 1−2b(8i+2)=x₁; 1−2b(8i+4)=x₂; 1−2b(8i+6)=x₃, then the real part of the above can be written as (note, x₀, x₁, x₂, x₃ all take values in {+1, −1}):

$${d}_{re} = \frac{1}{\sqrt{170}} \cdot {x}_{0} [ 8 - {x}_{1} [ 4 - {x}_{2} ( 2 - {x}_{3} ) ] ] .$$

The imaginary part of the constellation can be written in similar form. Now, if the power of the above expression is evaluated, and the fact that xᵢ²=1 for all i=0, 1, 2, 3, one obtains:

$${d}_{re}^{2} ∝ - 32 {x}_{1} - 4 ( 2 - {x}_{3} ) {x}_{2} + S ( 2 - {x}_{3} ) {x}_{1} {x}_{2}$$

and it is observed that that the power of the constellation depends on the x values through the terms x₁, x₂, x₁x₂.

In one example, two bits may be shaped, where bit b₁ and bit b₂ are shaped via v₁ and v₂. The power for the “masked” constellation point j can be re-written as follows:

$${d}_{r e}^{2} ( {v}_{1}^{( j )} , {v}_{2}^{( j )} ) ∞ - 32 {x}_{1}^{( j )} ( 1 - 2 {v}_{1}^{( j )} ) - 4 ( 2 - {x}_{3}^{( j )} ) {x}_{2}^{( j )} ( 1 - 2 {v}_{2}^{( j )} ) + 8 ( 2 - {x}_{3}^{( j )} ) {x}_{1}^{( j )} {x}_{2}^{( j )} ( 1 - 2 {v}_{1}^{( j )} ) ( 1 - 2 {v}_{2}^{( j )} ) . \qquad Equation ( 2 )$$

The goal is to find masking bit sequences

$${\{ {v}_{1}^{( j )} , {v}_{2}^{( j )} \}}_{j = 0 , … , n - 1} ,$$

from a codebook generated by a linear code (of k information bits, and blocklength 2n) that minimizes the above equation for a given data payload

$$\{ {x}_{1}^{( j )} , {x}_{2}^{( j )} , {x}_{3}^{( j )} \} .$$

In some cases, the transmitter may treat the sequence of real numbers

$${\{ 32 {x}_{1}^{( j )} , ( 2 - {x}_{3}^{( j )} ) {x}_{2}^{( j )} , - 8 ( 2 - {x}_{3}^{( j )} ) {x}_{1}^{( j )} {x}_{2}^{( j )} \}}_{j = 0 , … , n - 1}$$

as the received signal corresponding to a concatenated code, where an inner code is a (k,2n) linear shaping code, and the outer code is a (2,3) simplex code [v₁, v₂, v₁⊕v₂]. For example, the outer code may take every two masking bits

$$( {v}_{1}^{( j )} , {v}_{2}^{( j )} )$$

associated with a same modulation constellation and encode to three bits

$$( {v}_{1}^{( j )} , {v}_{2}^{( j )} , {v}_{1}^{( j )} ⊕ {v}_{2}^{( j )} ) ,$$

where ⊕ (denotes a bit-wise exclusive-OR (XOR) operation. Note that, the sign of the log likelihood ratios (LLRs) are reversed compared to Equation (2) because for shaping the transmit power is desired to be minimized, but for decoding the correlation of the received signal and the transmitted codeword is desired to be maximized. With the above approach, the transmitter may decode the concatenated code and obtain the shaping bits {sᵢ}_{i=0, . . . , k-1} as well as the masking bits

$${\{ {v}_{1}^{( j )} , {v}_{2}^{( j )} \}}_{j = 0 , … , n - 1} .$$

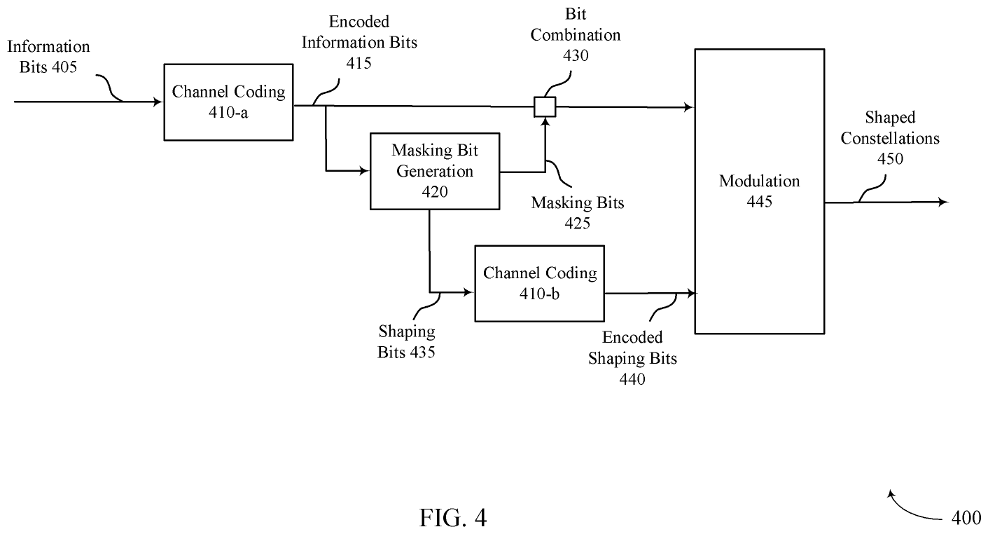

Various examples of shaping bit and masking bit generation are discussed herein. The transmitter may apply the masking bits to each modulation symbol to generate probabilistically shaped modulation symbols that are transmitted to a receiver. The transmitter may also transmit an indication of the shaping bits to the receiver for use in decoding the transmitted modulation symbols. Examples of transmission and reception schemes for probabilistically shaped modulation symbols are discussed for various examples with reference to FIGS. 4 through 7.

FIG. 4 illustrates an example of a transmission scheme 400 that supports techniques for joint probabilistic shaping of multiple bits per modulation constellation in accordance with one or more aspects of the present disclosure. FIG. 4 may be an example of one or more features of a framework for probabilistic shaping for higher-order modulation. The framework may include one or more of the features described with reference to FIGS. 2 and 3. For example, FIG. 4 illustrates one or more techniques for the processing of information bits 405 (e.g., u) for coding, shaping, and modulating information bits 405 (e.g., data) for transmission (e.g., using one or more shaping techniques described herein).

For example, a transmitting device (e.g., a UE 115, a network entity 105) may directly encode the information bits 405 using a channel coding 410-a (e.g., a channel coding scheme). After performing the channel coding, the information bits 405 may be referred to as encoded information bits 415 (e.g., x). At 420, the transmitting device may generate a set of masking bits 425 using the encoded information bits 415, where the set of masking bits 425 may have a same quantity of bits (e.g., n bits) as the encoded information bits 415. The masking bits may be used to shape the encoded information bits 415 by applying a masking, or scrambling to the encoded information bits 415. The set of masking bits 425 may be a sequence of bits (e.g., v bits) that may depend on the encoded information bits 415 (e.g., x), such that the combination of the set of masking bits 425 and the encoded information bits 415 (e.g., x⊕v) may not be uniformly distributed (e.g., may achieve the shaped or probabilistic distribution) through application of shaping to two or more bits per modulation constellation.

For example, after modulation, the combination of the set of masking bits 425 and the encoded information bits 415 (e.g., x⊕v) may result in a desired distribution (e.g., non-uniform distribution) of modulated symbols. In some examples, information about the set of masking bits 425 may not be available to a receiving device (e.g., a UE 115, a network entity 105). As such, information associated with the set of masking bits 425 may be transmitted to the receiver for deshaping and decoding received information bits. For example, as discussed herein, the transmitting device may generate a set of shaping bits 435 that may be used for generating a mask (e.g., v, the set of masking bits 425) for masking the encoded information bits 415. For example, the shaping bits 435 may be generated by decoding a concatenated code as discussed herein, and the masking bits 425 may be equal to the shaping bits 435 multiplied by a generator matrix (e.g., G). In some examples, the masking bits 425 may be generated (e.g., re-generated by the receiving device, generated by the transmitting device) from the shaping bits 435 via a linear block code (e.g., polar code, other code) using the generator matrix.

At 430, the transmitting device may mask, or shape, the encoded information bits 415 by combining (e.g., adding) the encoded information bits 415 with the set of masking bits 425. As described herein, the combination of the masking bits 425 and encoded information bits 415 may produce a desired distribution of symbols after modulation (e.g., a non-uniform distribution of symbols). At 445, the shaped, encoded information bits 415 may be modulated by the transmitting device (e.g., for transmission to the receiving device), which may generate one or more shaped constellations 450 of modulated symbols in which two or more bits per modulation symbol are probabilistically shaped.

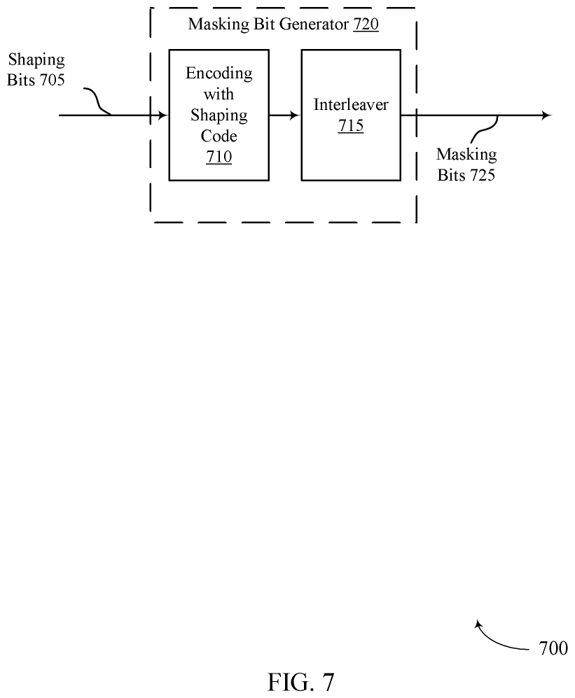

In this example, the shaping bits 435 may be channel coded using a channel coding 410-b, which may generate encoded shaping bits 440. The channel coding 410-b may represent a different or separate channel coding than channel coding 410-a, such that the set of shaping bits 435 may be separately encoded from the information bits 405. As such, the encoded information bits 415 and the encoded shaping bits 440 may use different coding rates, different modulation orders, different quantities of spatial layers, or the like. At 445, the encoded shaping bits 440 may be modulated by the transmitting device (e.g., for transmission to the receiving device). It is noted that while channel coding 410-a in this example is performed prior to applying the masking bits to the information bits, in other examples channel coding may be performed subsequent to masking the information bits. In some examples, masking bits may be interleaved, as discussed in more detail with reference to FIG. 7.

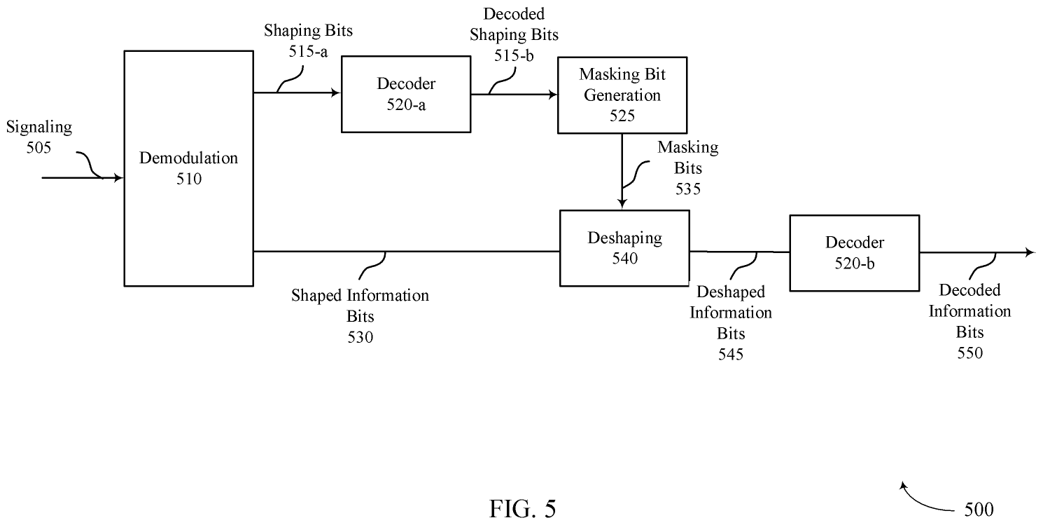

FIG. 5 illustrates an example of a reception scheme 500 that supports techniques for joint probabilistic shaping of multiple bits per modulation constellation in accordance with one or more aspects of the present disclosure. The reception scheme 500 may be used by a receiving device (e.g., a UE 115, a network entity 105), that may receive and demodulate signaling 505. For example, the receiving device may receive shaped constellations of modulated symbols from a transmitting device, such as those described with reference to FIGS. 2 through 4. The signaling 505 transmitted to the receiving device may be example of the bits 215 described with reference to FIG. 2.

The receiving device may receive the signaling 505 and demodulate the signaling 505 at 510. The signaling 505 may include payload information (e.g., u, information bits), associated shaping bits (e.g., s), or both. The demodulation may generate shaping bits 515-a, shaped information bits 530, or both. The shaped information bits 530 may, for example, represent log likelihood ratios (LLRs) corresponding to the shaped information bits 530, where the shaped information bits 530 may be a combination of information bits and masking bits (e.g., v+x). A decoder 520-a may decode (e.g., based on a channel coding scheme) shaping bits 515-a received via the signaling 505, which may generate decoded shaping bits 515-b. At 525, the receiving device may generate a set of masking bits 535 (e.g., v) using the decoded shaping bits 515-b (e.g., s). For example, the receiving device may decompress the decoded shaping bits 515-b to generate the set of masking bits 535, such as by multiplying the shaping bits 515-b by a generator matrix (e.g., a generator matrix G, where v=s*G), or other matrix or code.

The shaped information bits 530 may be deshaped at 540, using the set of masking bits 535. The deshaping process may generate deshaped information bits 545, which may, for example, represent LLRs corresponding to the deshaped information bits 545. The deshaping 540 may, for example, demask the shaped information bits 530, by removing the set of masking bits 535, or the results of the set of masking bits 535, from the shaped information bits 530 (e.g., remove the LLR(s) associated with the set of masking bits 535 to generate the LLRs for the unmasked information bits).

The deshaped information bits 545 (e.g., LLRs thereof) may be decoded using a decoder 520-b to generate decoded information bits 550. For example, the decoded information bits 550 may represent an information payload (e.g., u) decoded from the channel code used to encode the information payload. The decoder 520-b may be associated with a first or different decoding scheme than that associated with decoder 520-a. As such, the shaping bits 515 may be separately decoded from the information bits 550, and the information bits 550 and the shaping bits 515 may be associated with different coding rates, different modulation orders, different quantities of spatial layers, or the like.

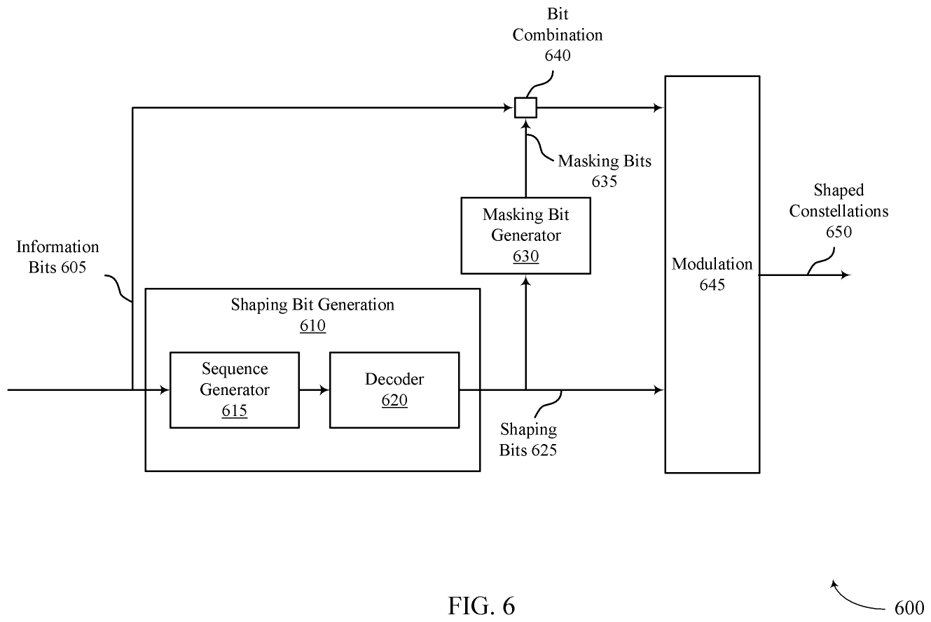

FIG. 6 illustrates another example of a transmission scheme 600 that supports techniques for joint probabilistic shaping of multiple bits per modulation constellation in accordance with one or more aspects of the present disclosure. FIG. 6 may be an example of one or more features of a framework for probabilistic shaping for higher-order modulation. The framework may include one or more of the features described with reference to FIGS. 2 through 5. For example, FIG. 6 illustrates one or more techniques for the processing of information bits 605, such as a data payload

$${\{ {b}_{0}^{( j )} , {b}_{1}^{( j )} , {b}_{2}^{( j )} , {b}_{3}^{( j )} \}}_{j = 0 , … , n - 1} ,$$

for coding, shaping, and modulating information bits 605 (e.g., data) for transmission (e.g., using one or more shaping techniques described herein).

In this example, information bits 605 may be provided for shaping bit generation 610, where a signal generator 615 may generate a sequence of signals corresponding to a sequence of terms of a mapping function between the set of information bits and a modulation symbol. For example, a 256-QAM modulation order may be used, with two-bit shaping. As indicated, the information bits 605 may include a data payload as

$${\{ {b}_{0}^{( j )} , {b}_{1}^{( j )} , {b}_{2}^{( j )} , {b}_{3}^{( j )} \}}_{j = 0 , … , n - 1} .$$

The shaping bit generation 610 may use decoding based on a concatenated code, such as discussed above with reference to FIG. 3, and signal generator 615 may provide the sequence of signals to be provided to decoder 620 of the concatenated code as:

$${\{ 32 {x}_{1}^{( j )} , ( 2 - {x}_{3}^{( j )} ) {x}_{2}^{( j )} , - 8 ( 2 - {x}_{3}^{( j )} ) {x}_{1}^{( j )} {x}_{2}^{( j )} \}}_{j = 0 , … , n - 1} .$$

In this example, the decoder 620 may decode this sequence of signals using an inner code and an outer code to generate a shaping bit sequence 625 ({sᵢ}_{i=0, . . . , k-1}) and a masking bit generator 630 may generate a set of masking bits 635 as

$${\{ {v}_{1}^{( j )} , {v}_{2}^{( j )} \}}_{j = 0 , … , n - 1} = {\{ {s}_{i} \}}_{i = 0 , … k - 1} \cdot G .$$

At 640, the transmitting device may mask, or shape, the data payload by combining (e.g., adding) the data payload with the set of masking bits 435, to generate shaped bits

$${\{ {b}_{0}^{( j )} , {b}_{1}^{( j )} ⊕ {v}_{1}^{( j )} , {b}_{2}^{( j )} ⊕ {v}_{2}^{( j )} , {b}_{3}^{( j )} \}}_{j = 0 , … , n - 1} ,$$

which may be modulated at 645 to generate shaped constellations 650.

As discussed, in some cases the shaping bit sequence 625 may be decoded based on a concatenated code and the described sequence of signals. For example, the shaping bit sequence 625 may be decoded using a decoder associated with the concatenated code. Such decoding to generate the shaping bit sequence 625 may be performed using any of multiple decoding techniques. In some cases, for example, the transmitter may jointly decode the inner code and outer code. Alternatively, the transmitter may decode the outer code (e.g., using a soft decoder) first and then proceed to decode the inner code. In one example, the transmitter may first generate intermediate LLRs from the outer code decoder, and then decode the inner code using the intermediate LLRs. In examples where the outer code is a (2,3) simplex code, first (from Equation (2)) LLR(v₁)=32x₁, LLR(v₂)=4x₂(2−x₃), and LLR(v₁⊕v₂)=−8x₁x₂(2−x₃) is generated. The extrinsic LLR of v₁ can be computed from LLR(v₂)=4x₂(2−x₃), and LLR(v₁⊕v₂)=−8x₁x₂(2−x₃) as LLRₑₓₜ(v₁)=−4x₁(2−x₃). This implies that the a posterior LLR for v₁ after decoding outer code is LLRₐₚ(v₁)=32x₁−4x₁(2−x₃). Similarly, the extrinsic LLR of v₂ can be computed from LLR(v₁)=32x₁, LLR(v₁⊕v₂)=−8x₁x₂(2−x₃) as LLRₑₓₜ(v₂)=−8x₂(2−x₃)=>LLRₐₚ(v₂)=4x₂(2−x₃)−8x₂(2−x₃)=−4x₂(2−x₃). Then, from the LLR values LLRₐₚ(v₁) and LLRₐₚ(v₂), the shaping bits {sᵢ}_{i=0, . . . , k-1} can be decoded, and the masking bit

$${\{ {v}_{1}^{( j )} , {v}_{2}^{( j )} \}}_{j = 0 , … , n - 1}$$

can be generated (e.g., as a product of the shaping bits and a generator matrix).

As discussed herein, described techniques may be used to provide shaping for two or more bits per modulation symbol. For example, for three-bit shaping in 256-QAM, such techniques may be used to decode a concatenated code to generate shaping bits and masking bits. In a three-bit example, assume that shaping bits

$$[ {v}_{1}^{( j )} , {v}_{2}^{( j )} , {v}_{3}^{( j )} ]$$

are used on bits

$$[ {b}_{1}^{( j )} , {b}_{2}^{( j )} , {b}_{3}^{( j )} ]$$

of constellation j. In such cases, the power function may be written as:

$$\begin{matrix}{d}_{r e}^{2} ( {v}_{1}^{( j )} , {v}_{2}^{( j )} , {v}_{3}^{( j )} ) \\ ∝ - 32 {x}_{1}^{( j )} ( 1 - 2 {v}_{1}^{( j )} ) - 8 {x}_{2}^{( j )} ( 1 - 2 {v}_{2}^{( j )} ) \\ - 2 {x}_{3}^{( j )} ( 1 - 2 {v}_{3}^{( j )} ) + 16 {x}_{1}^{( j )} {x}_{2}^{( j )} ( 1 - 2 {v}_{1}^{( j )} ) ( 1 - 2 {v}_{2}^{( j )} ) \\ + 4 {x}_{2}^{( j )} {x}_{3}^{( j )} ( 1 - 2 {v}_{2}^{( j )} ) ( 1 - 2 {v}_{3}^{( j )} ) \\ - 8 {x}_{1}^{( j )} {x}_{2}^{( j )} {x}_{3}^{( j )} ( 1 - 2 {v}_{1}^{( j )} ) ( 1 - 2 {v}_{2}^{( j )} ) ( 1 - 2 {v}_{3}^{( j )} )\end{matrix}$$

In this case, the inner code maps a k bit shaping sequence {sᵢ}_{i=0, . . . , k-1} into 3n masking bits

$${\{ {v}_{1}^{( j )} , {v}_{2}^{( j )} , {v}_{3}^{( j )} \}}_{j = 0 , … , n - 1} ;$$

and the outer code encodes every bit tuple

$$[ {v}_{1}^{( j )} , {v}_{2}^{( j )} , {v}_{3}^{( j )} ]$$

into a codeword

$$[ {v}_{1}^{( j )} , {v}_{2}^{( j )} , {v}_{3}^{( j )} , {v}_{1}^{( j )} ⊕ {v}_{2}^{( j )} , {v}_{2}^{( j )} ⊕ {v}_{3}^{( j )} , {v}_{1}^{( j )} ⊕ {v}_{2}^{( j )} ⊕ {v}_{3}^{( j )} ] .$$

The sequence of signals corresponding to the concatenated code are given by the bolded terms in the power equation, which may then be decoded to generate the shaping bits and masking bits as discussed above.

FIG. 7 illustrates an example of a interleaving scheme 700 that supports techniques for joint probabilistic shaping of multiple bits per modulation constellation in accordance with one or more aspects of the present disclosure. FIG. 7 may be an example of one or more features of a framework for probabilistic shaping for higher-order modulation. The framework may include one or more of the features described with reference to FIGS. 2 through 6. In this example, masking bits may be mapped to the modulation constellation using an interleaver 715.

As discussed, a shaping bit generator may use decoding of a concatenated code to generate a set of shaping bits 705 (e.g., {sᵢ}_{i=0, . . . , k-1}), which may be provided to masking bit generator 720. The masking bit generator 720 may perform encoding with a shaping code 710. One example of a shaping code may be a linear shaping code in which masking bits may be generated from the shaping bits through multiplication with a generator matrix (e.g., {sᵢ}_{i=0 . . . , k-1}·G). While examples discussed herein illustrate a linear shaping code, the shaping code can be non-linear and, in such cases, the masking bits are generated from the shaping bits through a non-linear encoder. The transmitter may associate the output of the shaping code to the masking bits, and may determine how and where to apply the masking bits to the data payload. In this example, this is done via an interleaver 715 that may provide a one-to-one mapping/permutation function between the masking bits and the output of the inner linear shaping code, to generate masking bits 725

$$( e . g . , {\{ {v}_{1}^{( j )} , {v}_{2}^{( j )} \}}_{j = 0 , … , n - 1} ) .$$

The transmitter and the receiver may use the same interleaver to generate the masking bits from the shaping bits. The interleaver 715 may also be used in the shaping decoder at the transmitter before sending the signals to the decoder of the concatenated codes. In some cases, the interleaver 715 may improve the shaping performance to provide certain constellation points with a higher probability of being selected for conveying associated information bits. For example, a triangle interleaver (e.g., an interleaver that writes an input signal column by column into respective rows of an upper/lower triangle, and generates an output signal by reading the signal from the triangle row by row (respectively column by column) may be used in cases where polar code is used as the shaping code. In other examples, a systematic bit prioritization mapping (SBPM) interleaver may be used in cases where LDPC code is used as the shaping code. Moreover, prioritization of the systematic bits of the LDPC code to the MSB of the shaped constellation points (e.g., b₁>b₂>b₃ in the 256-QAM case) may be performed.

As discussed, in some cases the transmitter may indicate the number of shaped bits per constellation to the receiver. In some cases, the number of shaped bits per constellation may be a function of the modulation order, the overall spectral efficiency, or both. In such cases, the number of shaped bits per constellation may be jointly signaled with a modulation and coding scheme (MCS) indication (e.g., configured as an additional parameter in an MCS table). Further, in some cases the number of bits per constellation could be fractional. In such cases, the number of shaped bits per constellation could be different for different modulation symbols in the same transmission (e.g., 1.5 bits means that 50% of the modulation symbols have two bits being shaped, and 50% of the modulation symbols have one bit being shaped).

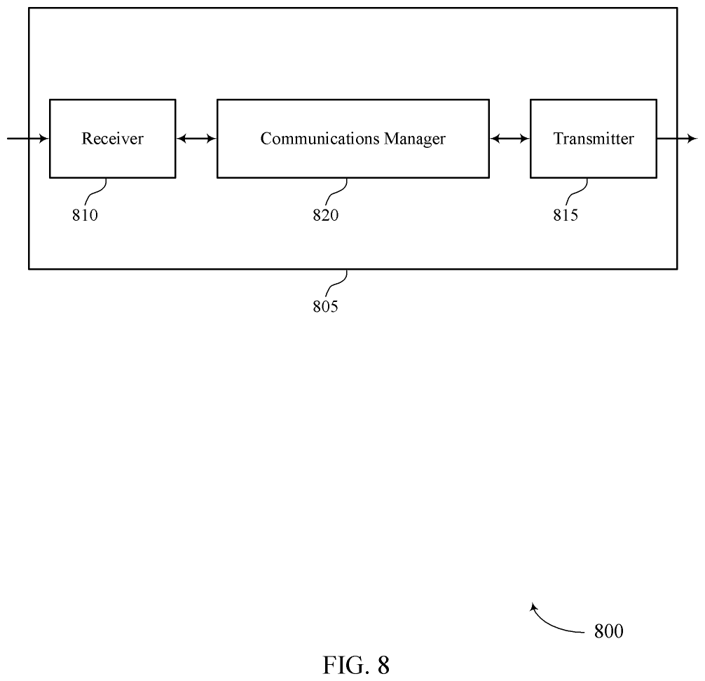

FIG. 8 shows a block diagram 800 of a device 805 that supports techniques for joint probabilistic shaping of multiple bits per modulation constellation in accordance with one or more aspects of the present disclosure. The device 805 may be an example of aspects of a UE 115 or a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for joint probabilistic shaping of multiple bits per modulation constellation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for joint probabilistic shaping of multiple bits per modulation constellation). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for joint probabilistic shaping of multiple bits per modulation constellation as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a transmitting device in accordance with examples as disclosed herein. For example, the communications manager 820 may be configured as or otherwise support a means for identifying a set of information bits that are to be transmitted to a receiving device. The communications manager 820 may be configured as or otherwise support a means for identifying a sequence of signals based on a modulation function between the set of information bits and a set of modulation symbols. The communications manager 820 may be configured as or otherwise support a means for generating, based on the sequence of signals, a shaping bit sequence, where the shaping bit sequence is generated from a decoder of a code applied to the sequence of signals. The communications manager 820 may be configured as or otherwise support a means for generating a set of probabilistically shaped modulation symbols based on the set of information bits and the shaping bit sequence, where probabilistic shaping is applied for two or more bits of the set of information bits that are transmitted via the set of probabilistically shaped modulation symbols. The communications manager 820 may be configured as or otherwise support a means for transmitting the set of information bits to the receiving device using the set of probabilistically shaped modulation symbols.

Additionally, or alternatively, the communications manager 820 may support wireless communication at a receiving device in accordance with examples as disclosed herein. For example, the communications manager 820 may be configured as or otherwise support a means for receiving, from a transmitting device, a set of probabilistically shaped modulation symbols that are used to transmit a set of information bits and a shaping bit sequence, where the shaping bit sequence indicates probabilistic shaping that is applied to the set of probabilistically shaped modulation symbols, the probabilistic shaping applied for two or more bits of the set of information bits that are transmitted via the set of probabilistically shaped modulation symbols. The communications manager 820 may be configured as or otherwise support a means for determining a set of masking bits based on the shaping bit sequence and a matrix. The communications manager 820 may be configured as or otherwise support a means for applying the set of masking bits to the set of probabilistically shaped modulation symbols to generate an encoded set of information bits. The communications manager 820 may be configured as or otherwise support a means for decoding the encoded set of information bits to determine the set of information bits.

Additionally, or alternatively, the communications manager 820 may support wireless communication at a transmitting device in accordance with examples as disclosed herein. For example, the communications manager 820 may be configured as or otherwise support a means for identifying a set of information bits that are to be transmitted to a receiving device. The communications manager 820 may be configured as or otherwise support a means for identifying a quantity of probabilistically shaped bits per modulation symbol associated with a probabilistic shaping scheme for shaping the set of information bits into a probability distribution of modulated symbols. The communications manager 820 may be configured as or otherwise support a means for generating a set of masking bits from the set of information bits, where the masking bits are determined based on the quantity of probabilistically shaped bits per modulation symbol. The communications manager 820 may be configured as or otherwise support a means for applying the set of masking bits to the set of information bits to form a set of shaped information bits. The communications manager 820 may be configured as or otherwise support a means for modulating the set of shaped information bits into probabilistically shaped modulated symbols based on the probabilistic shaping scheme.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for probabilistic shaping of modulation symbols that provide reduced processing, reduced power consumption, more efficient utilization of communication resources, and enhanced reliability.

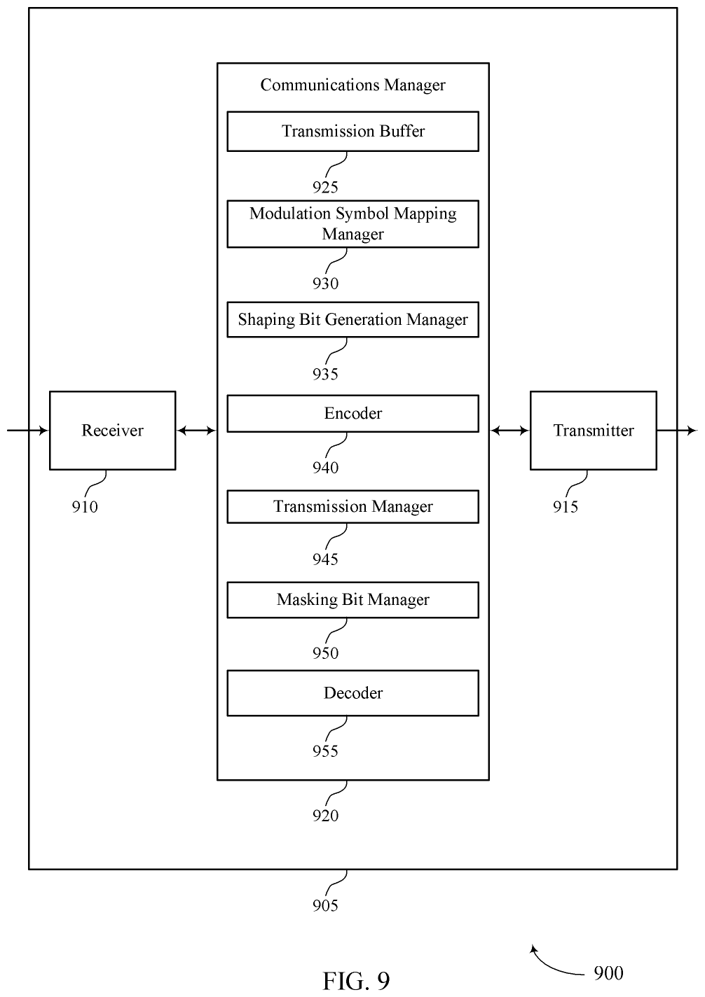

FIG. 9 shows a block diagram 900 of a device 905 that supports techniques for joint probabilistic shaping of multiple bits per modulation constellation in accordance with one or more aspects of the present disclosure. The device 905 may be an example of aspects of a device 805, a UE 115, or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for joint probabilistic shaping of multiple bits per modulation constellation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for joint probabilistic shaping of multiple bits per modulation constellation). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for joint probabilistic shaping of multiple bits per modulation constellation as described herein. For example, the communications manager 920 may include a transmission buffer 925, a modulation symbol mapping manager 930, a shaping bit generation manager 935, an encoder 940, a transmission manager 945, a masking bit manager 950, a decoder 955, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a transmitting device in accordance with examples as disclosed herein. The transmission buffer 925 may be configured as or otherwise support a means for identifying a set of information bits that are to be transmitted to a receiving device. The modulation symbol mapping manager 930 may be configured as or otherwise support a means for identifying a sequence of signals based at least in part on a modulation function between the set of information bits and a set of modulation symbols. The shaping bit generation manager 935 may be configured as or otherwise support a means for generating, based on the sequence of signals, a shaping bit sequence, where the shaping bit sequence is generated from a decoder of a code applied to the sequence of signals. The encoder 940 may be configured as or otherwise support a means for generating a set of probabilistically shaped modulation symbols based at least in part on the set of information bits and the shaping bit sequence, wherein probabilistic shaping is applied for two or more bits of the set of information bits that are transmitted via the set of probabilistically shaped modulation symbols. The transmission manager 945 may be configured as or otherwise support a means for transmitting the set of information bits to the receiving device using the set of probabilistically shaped modulation symbols.

Additionally, or alternatively, the communications manager 920 may support wireless communication at a receiving device in accordance with examples as disclosed herein. The modulation symbol mapping manager 930 may be configured as or otherwise support a means for receiving, from a transmitting device, a set of probabilistically shaped modulation symbols that are used to transmit a set of information bits and a shaping bit sequence, where the shaping bit sequence indicates probabilistic shaping that is applied to the set of probabilistically shaped modulation symbols, the probabilistic shaping applied for two or more bits of the set of information bits that are transmitted via the set of probabilistically shaped modulation symbols. The masking bit manager 950 may be configured as or otherwise support a means for determining a set of masking bits based on the shaping bit sequence and a matrix. The masking bit manager 950 may be configured as or otherwise support a means for applying the set of masking bits to the set of probabilistically shaped modulation symbols to generate an encoded set of information bits. The decoder 955 may be configured as or otherwise support a means for decoding the encoded set of information bits to determine the set of information bits.

Additionally, or alternatively, the communications manager 920 may support wireless communication at a transmitting device in accordance with examples as disclosed herein. The transmission buffer 925 may be configured as or otherwise support a means for identifying a set of information bits that are to be transmitted to a receiving device. The modulation symbol mapping manager 930 may be configured as or otherwise support a means for identifying a quantity of probabilistically shaped bits per modulation symbol associated with a probabilistic shaping scheme for shaping the set of information bits into a probability distribution of modulated symbols. The masking bit manager 950 may be configured as or otherwise support a means for generating a set of masking bits from the set of information bits, where the masking bits are determined based on the quantity of probabilistically shaped bits per modulation symbol. The masking bit manager 950 may be configured as or otherwise support a means for applying the set of masking bits to the set of information bits to form a set of shaped information bits. The transmission manager 945 may be configured as or otherwise support a means for modulating the set of shaped information bits into probabilistically shaped modulated symbols based on the probabilistic shaping scheme.

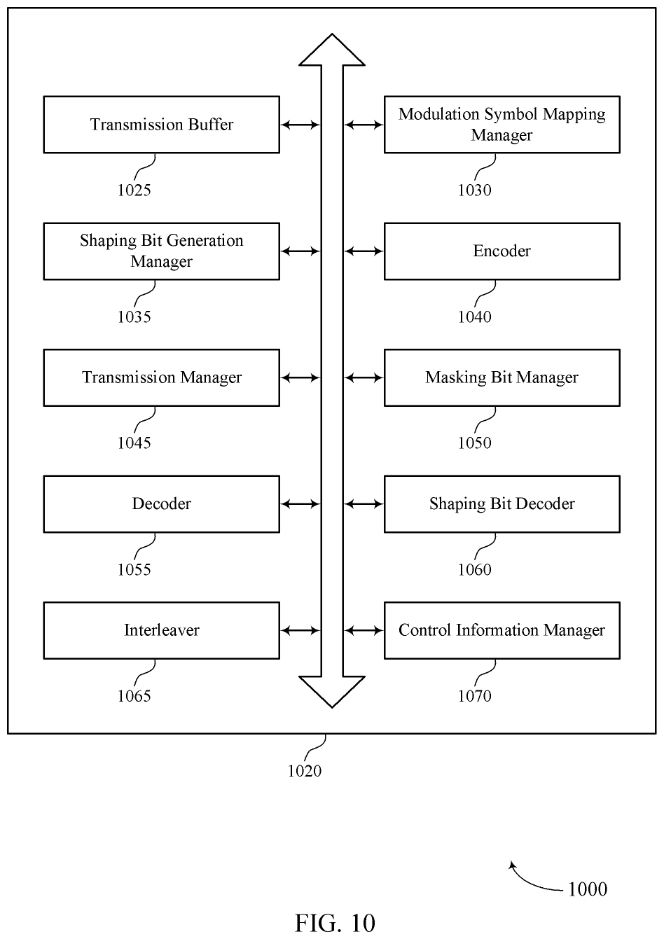

FIG. 10 shows a block diagram 1000 of a communications manager 1020 that supports techniques for joint probabilistic shaping of multiple bits per modulation constellation in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for joint probabilistic shaping of multiple bits per modulation constellation as described herein. For example, the communications manager 1020 may include a transmission buffer 1025, a modulation symbol mapping manager 1030, a shaping bit generation manager 1035, an encoder 1040, a transmission manager 1045, a masking bit manager 1050, a decoder 1055, a shaping bit decoder 1060, an interleaver 1065, a control information manager 1070, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication at a transmitting device in accordance with examples as disclosed herein. The transmission buffer 1025 may be configured as or otherwise support a means for identifying a set of information bits that are to be transmitted to a receiving device. The modulation symbol mapping manager 1030 may be configured as or otherwise support a means for identifying a sequence of signals based at least in part on a modulation function between the set of information bits and a set of modulation symbols. The shaping bit generation manager 1035 may be configured as or otherwise support a means for generating, based at least in part on the sequence of signals, a shaping bit sequence, wherein the shaping bit sequence is generated from a decoder of a code applied to the sequence of signals. The encoder 1040 may be configured as or otherwise support a means for generating a set of probabilistically shaped modulation symbols based at least in part on the set of information bits and the shaping bit sequence, wherein probabilistic shaping is applied for two or more bits of the set of information bits that are transmitted via the set of probabilistically shaped modulation symbols. The transmission manager 1045 may be configured as or otherwise support a means for transmitting the set of information bits to the receiving device using the set of probabilistically shaped modulation symbols.

In some examples, the sequence of signals is a sequence of real numbers that correspond to a sequence of terms of a mapping function between the set of information bits and the set of modulation symbols, and the code applied to the sequence of real numbers is a concatenated code including an inner code and an outer code. In some examples, the masking bit manager 1050 may be configured as or otherwise support a means for determining a set of masking bits based on a matrix associated with the inner code that is applied to the shaping bit sequence, and where the encoded set of information bits are determined based on the set of masking bits.

In some examples, the transmission manager 1045 may be configured as or otherwise support a means for transmitting the shaping bit sequence to the receiving device with the encoded set of information bits. In some examples, the shaping bit sequence is generated from decoding an outer code to convert a length 3n sequence of signals into a length 2n sequence of signals, and decoding an inner code to convert the length 2n sequence of signals into a length k shaping bit sequence, where n is a quantity of tuples of information bits that are to be transmitted using the shaping bit sequence. In some examples, a masking bit sequence is determined from the shaping bit sequence (e.g., based on a generator matrix applied to the shaping bit sequence), and the masking bit sequence is applied to the information bits to generate the probabilistically shaped modulation symbol, and where the masking bit sequence is the length 2n sequence of signals. In some examples, a masking bit sequence is determined from the shaping bit sequence, the shaping bit sequence is applied to a subset of the information bits to generate the set of probabilistically shaped modulation symbols, and the masking bit sequence has the second length.

In some examples, to support identifying the shaping bit sequence, the shaping bit decoder 1060 may be configured as or otherwise support a means for generating a set of intermediate LLRs from the sequence of signals based on an outer code. In some examples, to support identifying the shaping bit sequence, the shaping bit decoder 1060 may be configured as or otherwise support a means for decoding the set of intermediate LLRs based on an inner code to generate the shaping bit sequence. In some examples, the masking bit manager 1050 may be configured as or otherwise support a means for generating a masking bit sequence from the shaping bit sequence.

In some examples, the interleaver 1065 may be configured as or otherwise support a means for interleaving the masking bit sequence to generate an interleaved masking bit sequence that is applied to the set of information bits. In some examples, the interleaving is performed using a triangle interleaver when a polar code is used as the inner code. In some examples, the interleaving is performed using a systematic bit priority mapping (SBPM) interleaver when a low density parity code (LDPC) is used as inner code.

In some examples, the transmission manager 1045 may be configured as or otherwise support a means for transmitting an indication of a quantity of probabilistically shaped bits per modulation symbol to the receiving device. In some examples, a quantity of probabilistically shaped bits per modulation symbol is a function of a modulation order for communications, is indicated in a MCS table, or any combinations thereof. In some examples, the set of shaped modulation symbols includes a first subset of modulation symbols, and a second subset of modulation symbols, and where the first subset of modulation symbols includes a first number of bits that are shaped per modulation symbol, and the second subset of modulation symbols includes a second number of bits that are shaped per modulation symbol, and the first number of bits and second number of bits are different.

Additionally, or alternatively, the communications manager 1020 may support wireless communication at a receiving device in accordance with examples as disclosed herein. In some examples, the modulation symbol mapping manager 1030 may be configured as or otherwise support a means for receiving, from a transmitting device, a set of probabilistically shaped modulation symbols that are used to transmit a set of information bits and a shaping bit sequence, where the shaping bit sequence indicates probabilistic shaping that is applied to the set of probabilistically shaped modulation symbols, the probabilistic shaping applied for two or more bits of the set of information bits that are transmitted via the set of probabilistically shaped modulation symbols. The masking bit manager 1050 may be configured as or otherwise support a means for determining a set of masking bits based on the shaping bit sequence and a matrix. In some examples, the masking bit manager 1050 may be configured as or otherwise support a means for applying the set of masking bits to the set of probabilistically shaped modulation symbols to generate an encoded set of information bits. The decoder 1055 may be configured as or otherwise support a means for decoding the encoded set of information bits to determine the set of information bits.

In some examples, the set of masking bits are determined as a product of the matrix and the shaping bit sequence. In some examples, the shaping bit sequence is received in a separate set of modulation symbols than the set of probabilistically shaped modulation symbols. In some examples, the set of masking bits is a length 2n sequence and the shaping bit sequence is a length k sequence, where n is a quantity of tuples of information bits that are transmitted using the shaping bit sequence and k is a quantity of information bits in the set of information bits.

In some examples, the interleaver 1065 may be configured as or otherwise support a means for deinterleaving the set of masking bits based on an interleaver associated with communications from the receiving device. In some examples, the deinterleaving is performed using a triangle interleaver when a polar code is used for communications from the receiving device, or using a systematic bit priority mapping (SBPM) interleaver when a low density parity code (LDPC) is used for communications from the receiving device.

In some examples, the control information manager 1070 may be configured as or otherwise support a means for receiving an indication of a quantity of probabilistically shaped bits per modulation symbol from the transmitting device. In some examples, a quantity of probabilistically shaped bits per modulation symbol is a function of a modulation order for communications, is indicated in a MCS table, or any combinations thereof. In some examples, the set of shaped modulation symbols includes a first subset of modulation symbols, and a second subset of modulation symbols, and where the first subset of modulation symbols includes a first number of bits that are shaped per modulation symbol, and the second subset of modulation symbols includes a second number of bits that are shaped per modulation symbol, and the first number of bits and second number of bits are different.

Additionally, or alternatively, the communications manager 1020 may support wireless communication at a transmitting device in accordance with examples as disclosed herein. In some examples, the transmission buffer 1025 may be configured as or otherwise support a means for identifying a set of information bits that are to be transmitted to a receiving device. In some examples, the modulation symbol mapping manager 1030 may be configured as or otherwise support a means for identifying a quantity of probabilistically shaped bits per modulation symbol associated with a probabilistic shaping scheme for shaping the set of information bits into a probability distribution of modulated symbols. In some examples, the masking bit manager 1050 may be configured as or otherwise support a means for generating a set of masking bits from the set of information bits, where the masking bits are determined based on the quantity of probabilistically shaped bits per modulation symbol. In some examples, the masking bit manager 1050 may be configured as or otherwise support a means for applying the set of masking bits to the set of information bits to form a set of shaped information bits. In some examples, the transmission manager 1045 may be configured as or otherwise support a means for modulating the set of shaped information bits into probabilistically shaped modulated symbols based on the probabilistic shaping scheme.

In some examples, to support generating the set of masking bits, the decoder 1055 may be configured as or otherwise support a means for decoding a sequence of signals associated with the set of information bits based on an inner code to generate a shaping bit sequence. In some examples, to support generating the set of masking bits, the masking bit manager 1050 may be configured as or otherwise support a means for generating the set of masking bits based on a matrix that is applied to the shaping bit sequence.

In some examples, the interleaver 1065 may be configured as or otherwise support a means for interleaving the masking bit sequence to generate an interleaved masking bit sequence that is applied to the set of information bits prior to modulating the set of information bits. In some examples, the interleaving is performed using a triangle interleaver when a polar code is used as the inner code. In some examples, the interleaving is performed using a SBPM interleaver when a LDPC is used as inner code. In some examples, the transmission manager 1045 may be configured as or otherwise support a means for transmitting the probabilistically shaped modulated symbols and the shaping bit sequence to a receiving device.

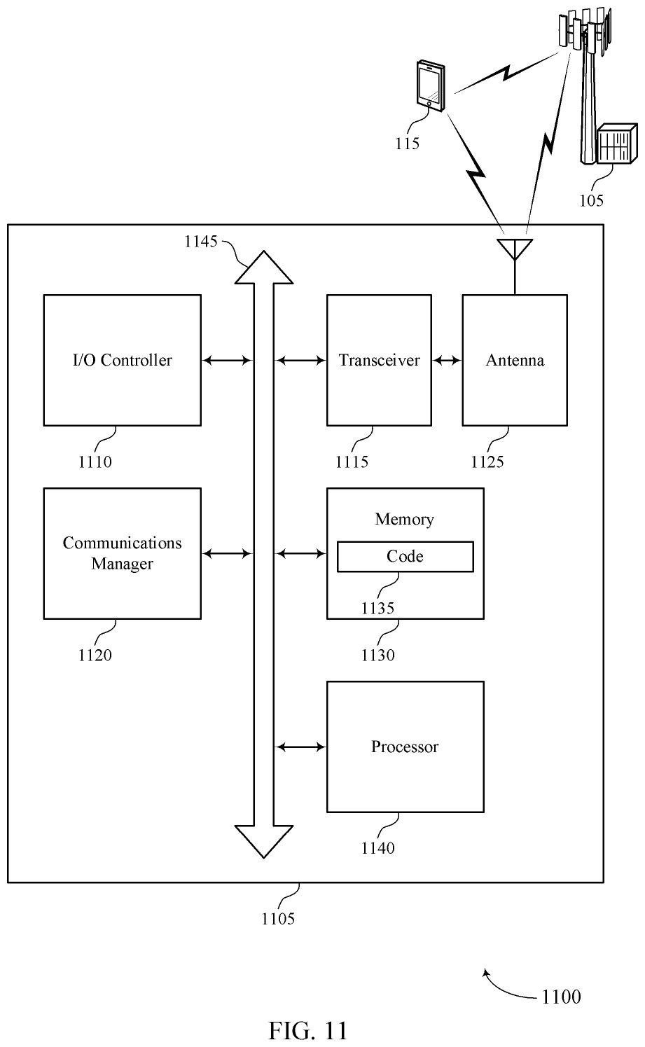

FIG. 11 shows a diagram of a system 1100 including a device 1105 that supports techniques for joint probabilistic shaping of multiple bits per modulation constellation in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for joint probabilistic shaping of multiple bits per modulation constellation). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a transmitting device in accordance with examples as disclosed herein. For example, the communications manager 1120 may be configured as or otherwise support a means for identifying a set of information bits that are to be transmitted to a receiving device. The communications manager 1120 may be configured as or otherwise support a means for identifying a sequence of signals based at least in part on a modulation function between the set of information bits and a set of modulation symbols. The communications manager 1120 may be configured as or otherwise support a means for generating, based on the sequence of signals, a shaping bit sequence, where the shaping bit sequence is generated from a decoder of a code applied to the sequence of signals. The communications manager 1120 may be configured as or otherwise support a means for generating a set of probabilistically shaped modulation symbols based on the set of information bits and the shaping bit sequence, where probabilistic shaping is applied for two or more bits of the set of information bits that are transmitted via the set of probabilistically shaped modulation symbols. The communications manager 1120 may be configured as or otherwise support a means for transmitting the set of information bits to the receiving device using the set of probabilistically shaped modulation symbols.

Additionally, or alternatively, the communications manager 1120 may support wireless communication at a receiving device in accordance with examples as disclosed herein. For example, the communications manager 1120 may be configured as or otherwise support a means for receiving, from a transmitting device, a set of probabilistically shaped modulation symbols that are used to transmit a set of information bits and a shaping bit sequence, where the shaping bit sequence indicates probabilistic shaping that is applied to the set of probabilistically shaped modulation symbols, the probabilistic shaping applied for two or more bits of the set of information bits that are transmitted via the set of probabilistically shaped modulation symbols. The communications manager 1120 may be configured as or otherwise support a means for determining a set of masking bits based on the shaping bit sequence and a matrix. The communications manager 1120 may be configured as or otherwise support a means for applying the set of masking bits to the set of probabilistically shaped modulation symbols to generate an encoded set of information bits. The communications manager 1120 may be configured as or otherwise support a means for decoding the encoded set of information bits to determine the set of information bits.

Additionally, or alternatively, the communications manager 1120 may support wireless communication at a transmitting device in accordance with examples as disclosed herein. For example, the communications manager 1120 may be configured as or otherwise support a means for identifying a set of information bits that are to be transmitted to a receiving device. The communications manager 1120 may be configured as or otherwise support a means for identifying a quantity of probabilistically shaped bits per modulation symbol associated with a probabilistic shaping scheme for shaping the set of information bits into a probability distribution of modulated symbols. The communications manager 1120 may be configured as or otherwise support a means for generating a set of masking bits from the set of information bits, where the masking bits are determined based on the quantity of probabilistically shaped bits per modulation symbol. The communications manager 1120 may be configured as or otherwise support a means for applying the set of masking bits to the set of information bits to form a set of shaped information bits. The communications manager 1120 may be configured as or otherwise support a means for modulating the set of shaped information bits into probabilistically shaped modulated symbols based on the probabilistic shaping scheme.

By including or configuring the communications manager 1120 in accordance with examples as described herein, the device 1105 may support techniques for probabilistic shaping of modulation symbols that provide reduced processing, reduced power consumption, more efficient utilization of communication resources, enhanced reliability, longer battery life, improved utilization of processing capability, or any combinations thereof.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for joint probabilistic shaping of multiple bits per modulation constellation as described herein, or the processor 1140 and the memory 1130 may be otherwise configured to perform or support such operations.

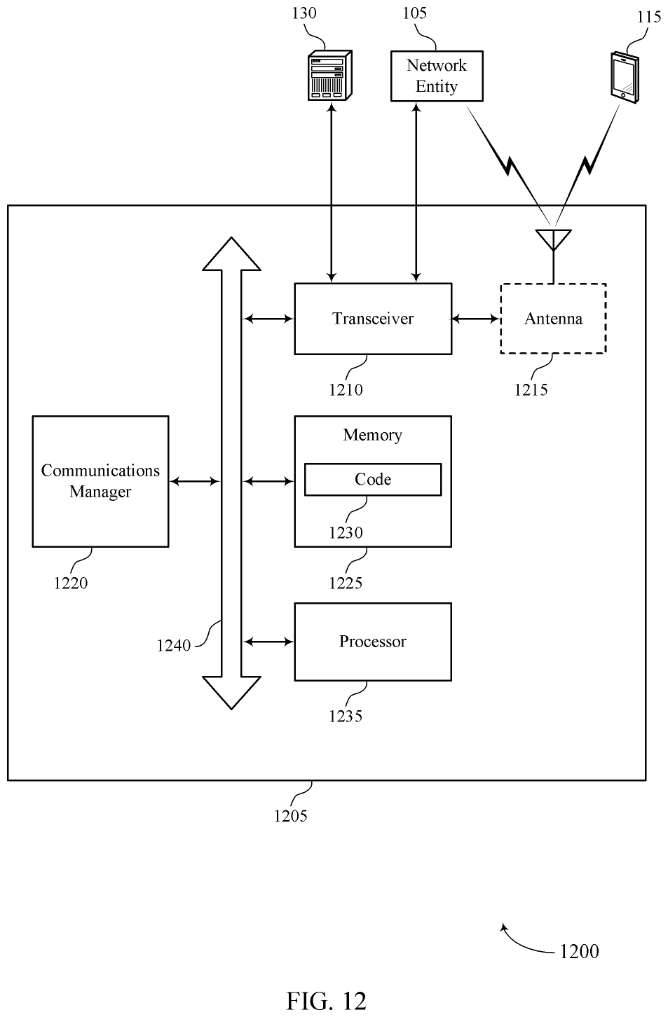

FIG. 12 shows a diagram of a system 1200 including a device 1205 that supports techniques for joint probabilistic shaping of multiple bits per modulation constellation in accordance with one or more aspects of the present disclosure. The device 1205 may be an example of or include the components of a device 805, a device 905, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. The transceiver 1210, or the transceiver 1210 and one or more antennas 1215 or wired interfaces, where applicable, may be an example of a transmitter 815, a transmitter 915, a receiver 810, a receiver 910, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting techniques for joint probabilistic shaping of multiple bits per modulation constellation). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 1205 may transmit information output from the chip or modem. In some implementations, the second interface may refer to an interface between the processing system of the chip or modem and a receiver, such that the device 1205 may obtain information or signal inputs, and the information may be passed to the processing system. A person having ordinary skill in the art will readily recognize that the first interface also may obtain information or signal inputs, and the second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a transmitting device in accordance with examples as disclosed herein. For example, the communications manager 1220 may be configured as or otherwise support a means for identifying a set of information bits that are to be transmitted to a receiving device. The communications manager 1220 may be configured as or otherwise support a means for identifying a sequence of signals based at least in part on a modulation function between the set of information bits and a set of modulation symbols. The communications manager 1220 may be configured as or otherwise support a means for generating, based on the sequence of signals, a shaping bit sequence, where the shaping bit sequence is generated from a decoder of a code applied to the sequence of signals. The communications manager 1220 may be configured as or otherwise support a means for generating a set of probabilistically shaped modulation symbols based at least in part on the set of information bits and the shaping bit sequence, wherein probabilistic shaping is applied for two or more bits of the set of information bits that are transmitted via the set of probabilistically shaped modulation symbols. The communications manager 1220 may be configured as or otherwise support a means for transmitting the set of information bits to the receiving device using the set of probabilistically shaped modulation symbols.

Additionally, or alternatively, the communications manager 1220 may support wireless communication at a receiving device in accordance with examples as disclosed herein. For example, the communications manager 1220 may be configured as or otherwise support a means for receiving, from a transmitting device, a set of probabilistically shaped modulation symbols that are used to transmit a set of information bits and a shaping bit sequence, where the shaping bit sequence indicates probabilistic shaping that is applied to the set of probabilistically shaped modulation symbols, the probabilistic shaping applied for two or more bits of the set of information bits that are transmitted via the set of probabilistically shaped modulation symbols. The communications manager 1220 may be configured as or otherwise support a means for determining a set of masking bits based on the shaping bit sequence and a matrix. The communications manager 1220 may be configured as or otherwise support a means for applying the set of masking bits to the set of probabilistically shaped modulation symbols to generate an encoded set of information bits. The communications manager 1220 may be configured as or otherwise support a means for decoding the encoded set of information bits to determine the set of information bits.

Additionally, or alternatively, the communications manager 1220 may support wireless communication at a transmitting device in accordance with examples as disclosed herein. For example, the communications manager 1220 may be configured as or otherwise support a means for identifying a set of information bits that are to be transmitted to a receiving device. The communications manager 1220 may be configured as or otherwise support a means for identifying a quantity of probabilistically shaped bits per modulation symbol associated with a probabilistic shaping scheme for shaping the set of information bits into a probability distribution of modulated symbols. The communications manager 1220 may be configured as or otherwise support a means for generating a set of masking bits from the set of information bits, where the masking bits are determined based on the quantity of probabilistically shaped bits per modulation symbol. The communications manager 1220 may be configured as or otherwise support a means for applying the set of masking bits to the set of information bits to form a set of shaped information bits. The communications manager 1220 may be configured as or otherwise support a means for modulating the set of shaped information bits into probabilistically shaped modulated symbols based on the probabilistic shaping scheme.

By including or configuring the communications manager 1220 in accordance with examples as described herein, the device 1205 may support techniques for probabilistic shaping of modulation symbols that provide reduced processing, reduced power consumption, more efficient utilization of communication resources, enhanced reliability, improved utilization of processing capability, or any combinations thereof.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of techniques for joint probabilistic shaping of multiple bits per modulation constellation as described herein, or the processor 1235 and the memory 1225 may be otherwise configured to perform or support such operations.

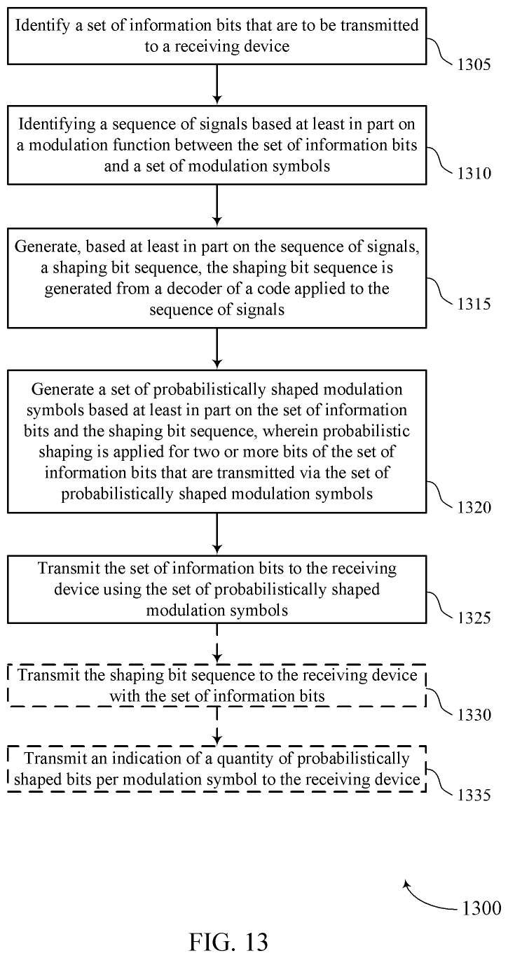

FIG. 13 shows a flowchart illustrating a method 1300 that supports techniques for joint probabilistic shaping of multiple bits per modulation constellation in accordance with one or more aspects of the present disclosure. The operations of the method 1300 may be implemented by a UE or a network entity or its components as described herein. For example, the operations of the method 1300 may be performed by a UE 115 or a network entity as described with reference to FIGS. 1 through 12. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1305, the method may include identifying a set of information bits that are to be transmitted to a receiving device. The operations of 1305 may be performed in accordance with examples as disclosed herein. In some examples, aspects of the operations of 1305 may be performed by a transmission buffer 1025 as described with reference to FIG. 10.

At 1310, the method may include identifying a sequence of signals based at least in part on a modulation function between the set of information bits and a set of modulation symbols. The operations of 1310 may be performed in accordance with examples as disclosed herein. In some examples, aspects of the operations of 1310 may be performed by a modulation symbol mapping manager 1030 as described with reference to FIG. 10.

At 1315, the method may include generating, based on the sequence of signals, a shaping bit sequence, where the shaping bit sequence is generated from a decoder of a code applied to the sequence of signals. The operations of 1315 may be performed in accordance with examples as disclosed herein. In some examples, aspects of the operations of 1315 may be performed by a shaping bit generation manager 1035 as described with reference to FIG. 10. In some cases, the shaping bit sequence provides a set of probabilistically shaped modulation symbols for transmission of the set of information bits to the receiving device, where probabilistic shaping is applied for two or more bits of the set of information bits that are transmitted via the set of probabilistically shaped modulation symbols.

At 1320, the method may include generating a set of probabilistically shaped modulation symbols based on the set of information bits and the shaping bit sequence, where probabilistic shaping is applied for two or more bits of the set of information bits that are transmitted via the set of probabilistically shaped modulation symbols. The operations of 1320 may be performed in accordance with examples as disclosed herein. In some examples, aspects of the operations of 1320 may be performed by an encoder 1040 as described with reference to FIG. 10.

At 1325, the method may include transmitting the set of information bits to the receiving device using the set of probabilistically shaped modulation symbols. The operations of 1325 may be performed in accordance with examples as disclosed herein. In some examples, aspects of the operations of 1325 may be performed by a transmission manager 1045 as described with reference to FIG. 10.

In some cases, at 1330, the method may include transmitting the shaping bit sequence to the receiving device with the set of information bits. The operations of 1330 may be performed in accordance with examples as disclosed herein. In some examples, aspects of the operations of 1330 may be performed by a transmission manager 1045 as described with reference to FIG. 10.

In some cases, at 1335, the method may include transmitting an indication of a quantity of probabilistically shaped bits per modulation symbol to the receiving device. The operations of 1335 may be performed in accordance with examples as disclosed herein. In some examples, aspects of the operations of 1335 may be performed by a transmission manager 1045 as described with reference to FIG. 10.

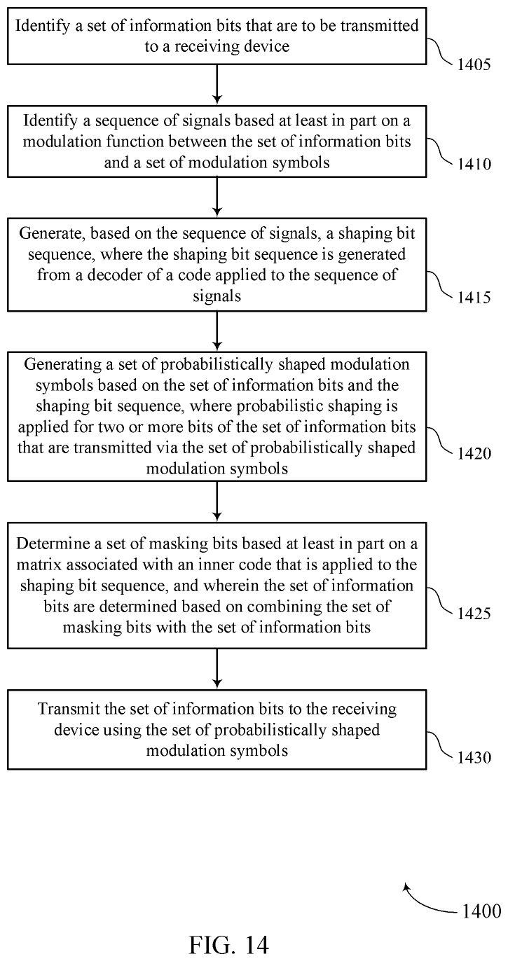

FIG. 14 shows a flowchart illustrating a method 1400 that supports techniques for joint probabilistic shaping of multiple bits per modulation constellation in accordance with one or more aspects of the present disclosure. The operations of the method 1400 may be implemented by a UE or a network entity or its components as described herein. For example, the operations of the method 1400 may be performed by a UE 115 or a network entity as described with reference to FIGS. 1 through 12. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1405, the method may include identifying a set of information bits that are to be transmitted to a receiving device. The operations of 1405 may be performed in accordance with examples as disclosed herein. In some examples, aspects of the operations of 1405 may be performed by a transmission buffer 1025 as described with reference to FIG. 10.

At 1410, the method may include identifying a sequence of signals based at least in part on a modulation function between the set of information bits and a set of modulation symbols. The operations of 1410 may be performed in accordance with examples as disclosed herein. In some examples, aspects of the operations of 1410 may be performed by a modulation symbol mapping manager 1030 as described with reference to FIG. 10. In some cases, the sequence of signals being a sequence of real numbers, and the code applied to the sequence of real numbers is a concatenated code including an inner code and an outer code.

At 1415, the method may include generating, based on the sequence of signals, a shaping bit sequence, where the shaping bit sequence is generated from a decoder of a code applied to the sequence of signals. The operations of 1415 may be performed in accordance with examples as disclosed herein. In some examples, aspects of the operations of 1415 may be performed by a shaping bit generation manager 1035 as described with reference to FIG. 10.

At 1420, the method may include encoding the set of information bits based on the shaping bit sequence to generate an encoded set of information bits. The operations of 1420 may be performed in accordance with examples as disclosed herein. In some examples, aspects of the operations of 1420 may be performed by an encoder 1040 as described with reference to FIG. 10.

At 1425, the method may include determining a set of masking bits based on a matrix associated with an inner code that is applied to the shaping bit sequence, and where the set of information bits are determined based on combining the set of masking bits with the set of information bits. The operations of 1425 may be performed in accordance with examples as disclosed herein. In some examples, aspects of the operations of 1425 may be performed by a masking bit manager 1050 as described with reference to FIG. 10.

At 1430, the method may include transmitting the set of information bits to the receiving device using the set of probabilistically shaped modulation symbols. The operations of 1430 may be performed in accordance with examples as disclosed herein. In some examples, aspects of the operations of 1430 may be performed by a transmission manager 1045 as described with reference to FIG. 10.

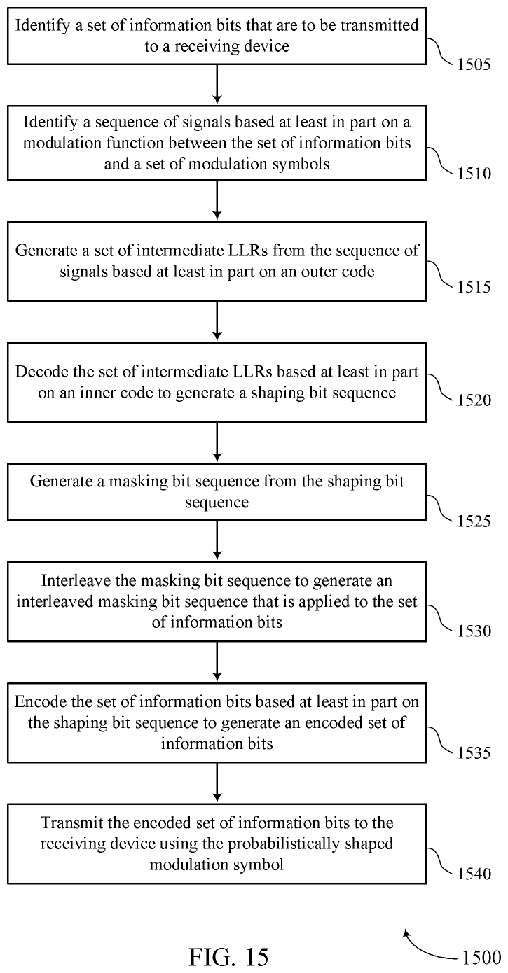

FIG. 15 shows a flowchart illustrating a method 1500 that supports techniques for joint probabilistic shaping of multiple bits per modulation constellation in accordance with one or more aspects of the present disclosure. The operations of the method 1500 may be implemented by a UE or a network entity or its components as described herein. For example, the operations of the method 1500 may be performed by a UE 115 or a network entity as described with reference to FIGS. 1 through 12. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1505, the method may include identifying a set of information bits that are to be transmitted to a receiving device. The operations of 1505 may be performed in accordance with examples as disclosed herein. In some examples, aspects of the operations of 1505 may be performed by a transmission buffer 1025 as described with reference to FIG. 10.

At 1510, the method may identifying a sequence of signals based at least in part on a modulation function between the set of information bits and a set of modulation symbols. The operations of 1510 may be performed in accordance with examples as disclosed herein. In some examples, aspects of the operations of 1510 may be performed by a modulation symbol mapping manager 1030 as described with reference to FIG. 10.

At 1515, the method may include generating a set of intermediate LLRs from the sequence of signals based on an outer code. The operations of 1515 may be performed in accordance with examples as disclosed herein. In some examples, aspects of the operations of 1515 may be performed by a shaping bit decoder 1060 as described with reference to FIG. 10.

At 1520, the method may include decoding the set of intermediate LLRs based on an inner code to generate a shaping bit sequence. The operations of 1520 may be performed in accordance with examples as disclosed herein. In some examples, aspects of the operations of 1520 may be performed by a shaping bit decoder 1060 as described with reference to FIG. 10.

At 1525, the method may include generating a masking bit sequence from the shaping bit sequence. The operations of 1525 may be performed in accordance with examples as disclosed herein. In some examples, aspects of the operations of 1525 may be performed by a masking bit manager 1050 as described with reference to FIG. 10.

At 1530, the method may include interleaving the masking bit sequence to generate an interleaved masking bit sequence that is applied to the set of information bits. The operations of 1530 may be performed in accordance with examples as disclosed herein. In some examples, aspects of the operations of 1530 may be performed by an interleaver 1065 as described with reference to FIG. 10.

At 1535, the method may include encoding the set of information bits based on the shaping bit sequence to generate an encoded set of information bits. The operations of 1535 may be performed in accordance with examples as disclosed herein. In some examples, aspects of the operations of 1535 may be performed by an encoder 1040 as described with reference to FIG. 10.

At 1540, the method may include transmitting the encoded set of information bits to the receiving device using the probabilistically shaped modulation symbol. The operations of 1540 may be performed in accordance with examples as disclosed herein. In some examples, aspects of the operations of 1540 may be performed by a transmission manager 1045 as described with reference to FIG. 10.

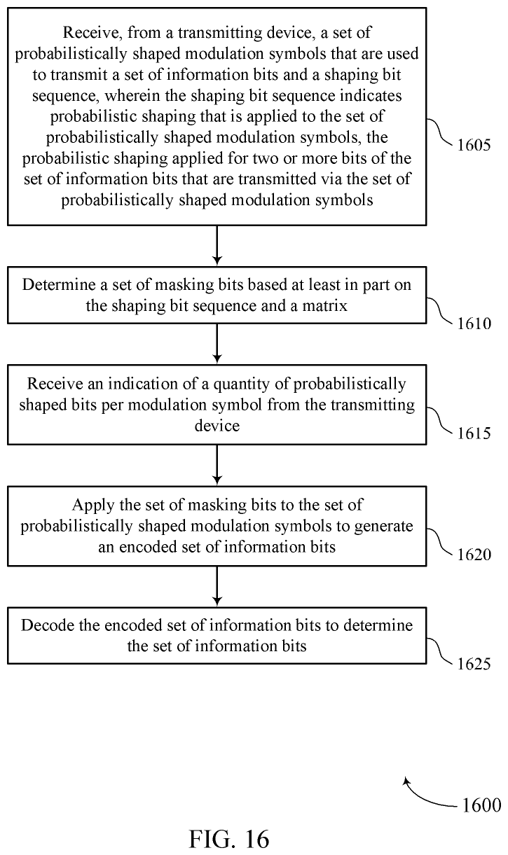

FIG. 16 shows a flowchart illustrating a method 1600 that supports techniques for joint probabilistic shaping of multiple bits per modulation constellation in accordance with one or more aspects of the present disclosure. The operations of the method 1600 may be implemented by a UE or a network entity or its components as described herein. For example, the operations of the method 1600 may be performed by a UE 115 or a network entity as described with reference to FIGS. 1 through 12. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1605, the method may include receiving, from a transmitting device, a set of probabilistically shaped modulation symbols that are used to transmit a set of information bits and a shaping bit sequence, where the shaping bit sequence indicates probabilistic shaping that is applied to the set of probabilistically shaped modulation symbols, the probabilistic shaping applied for two or more bits of the set of information bits that are transmitted via the set of probabilistically shaped modulation symbols. The operations of 1605 may be performed in accordance with examples as disclosed herein. In some examples, aspects of the operations of 1605 may be performed by a modulation symbol mapping manager 1030 as described with reference to FIG. 10.

At 1610, the method may include determining a set of masking bits based on the shaping bit sequence and a matrix. The operations of 1610 may be performed in accordance with examples as disclosed herein. In some examples, aspects of the operations of 1610 may be performed by a masking bit manager 1050 as described with reference to FIG. 10.

At 1615, the method may include receiving an indication of a quantity of probabilistically shaped bits per modulation symbol from the transmitting device. The operations of 1615 may be performed in accordance with examples as disclosed herein. In some examples, aspects of the operations of 1615 may be performed by a control information manager 1070 as described with reference to FIG. 10.

At 1620, the method may include applying the set of masking bits to the set of probabilistically shaped modulation symbols to generate an encoded set of information bits. The operations of 1620 may be performed in accordance with examples as disclosed herein. In some examples, aspects of the operations of 1620 may be performed by a masking bit manager 1050 as described with reference to FIG. 10.

At 1625, the method may include decoding the encoded set of information bits to determine the set of information bits. The operations of 1625 may be performed in accordance with examples as disclosed herein. In some examples, aspects of the operations of 1625 may be performed by a decoder 1055 as described with reference to FIG. 10.

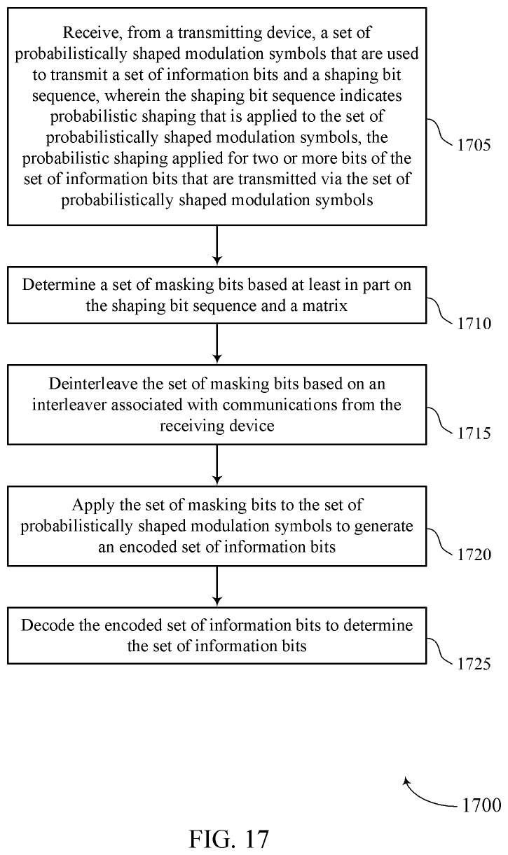

FIG. 17 shows a flowchart illustrating a method 1700 that supports techniques for joint probabilistic shaping of multiple bits per modulation constellation in accordance with one or more aspects of the present disclosure. The operations of the method 1700 may be implemented by a UE or a network entity or its components as described herein. For example, the operations of the method 1700 may be performed by a UE 115 or a network entity as described with reference to FIGS. 1 through 12. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1705, the method may include receiving, from a transmitting device, a set of probabilistically shaped modulation symbols that are used to transmit a set of information bits and a shaping bit sequence, where the shaping bit sequence indicates probabilistic shaping that is applied to the set of probabilistically shaped modulation symbols, the probabilistic shaping applied for two or more bits of the set of information bits that are transmitted via the set of probabilistically shaped modulation symbols. The operations of 1705 may be performed in accordance with examples as disclosed herein. In some examples, aspects of the operations of 1705 may be performed by a modulation symbol mapping manager 1030 as described with reference to FIG. 10.

At 1710, the method may include determining a set of masking bits based on the shaping bit sequence and a matrix. The operations of 1710 may be performed in accordance with examples as disclosed herein. In some examples, aspects of the operations of 1710 may be performed by a masking bit manager 1050 as described with reference to FIG. 10.

At 1715, the method may include deinterleaving the set of masking bits based on an interleaver associated with communications from the receiving device. The operations of 1715 may be performed in accordance with examples as disclosed herein. In some examples, aspects of the operations of 1715 may be performed by an interleaver 1065 as described with reference to FIG. 10.

At 1720, the method may include applying the set of masking bits to the set of probabilistically shaped modulation symbols to generate an encoded set of information bits. The operations of 1720 may be performed in accordance with examples as disclosed herein. In some examples, aspects of the operations of 1720 may be performed by a masking bit manager 1050 as described with reference to FIG. 10.

At 1725, the method may include decoding the encoded set of information bits to determine the set of information bits. The operations of 1725 may be performed in accordance with examples as disclosed herein. In some examples, aspects of the operations of 1725 may be performed by a decoder 1055 as described with reference to FIG. 10.

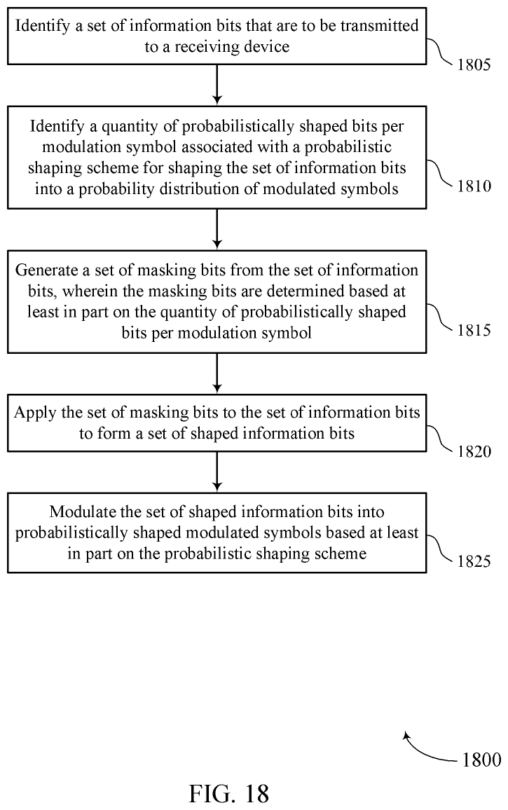

FIG. 18 shows a flowchart illustrating a method 1800 that supports techniques for joint probabilistic shaping of multiple bits per modulation constellation in accordance with one or more aspects of the present disclosure. The operations of the method 1800 may be implemented by a UE or a network entity or its components as described herein. For example, the operations of the method 1800 may be performed by a UE 115 or a network entity as described with reference to FIGS. 1 through 12. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1805, the method may include identifying a set of information bits that are to be transmitted to a receiving device. The operations of 1805 may be performed in accordance with examples as disclosed herein. In some examples, aspects of the operations of 1805 may be performed by a transmission buffer 1025 as described with reference to FIG. 10.

At 1810, the method may include identifying a quantity of probabilistically shaped bits per modulation symbol associated with a probabilistic shaping scheme for shaping the set of information bits into a probability distribution of modulated symbols. The operations of 1810 may be performed in accordance with examples as disclosed herein. In some examples, aspects of the operations of 1810 may be performed by a modulation symbol mapping manager 1030 as described with reference to FIG. 10.

At 1815, the method may include generating a set of masking bits from the set of information bits, where the masking bits are determined based on the quantity of probabilistically shaped bits per modulation symbol. The operations of 1815 may be performed in accordance with examples as disclosed herein. In some examples, aspects of the operations of 1815 may be performed by a masking bit manager 1050 as described with reference to FIG. 10.

At 1820, the method may include applying the set of masking bits to the set of information bits to form a set of shaped information bits. The operations of 1820 may be performed in accordance with examples as disclosed herein. In some examples, aspects of the operations of 1820 may be performed by a masking bit manager 1050 as described with reference to FIG. 10.

At 1825, the method may include modulating the set of shaped information bits into probabilistically shaped modulated symbols based on the probabilistic shaping scheme. The operations of 1825 may be performed in accordance with examples as disclosed herein. In some examples, aspects of the operations of 1825 may be performed by a transmission manager 1045 as described with reference to FIG. 10.

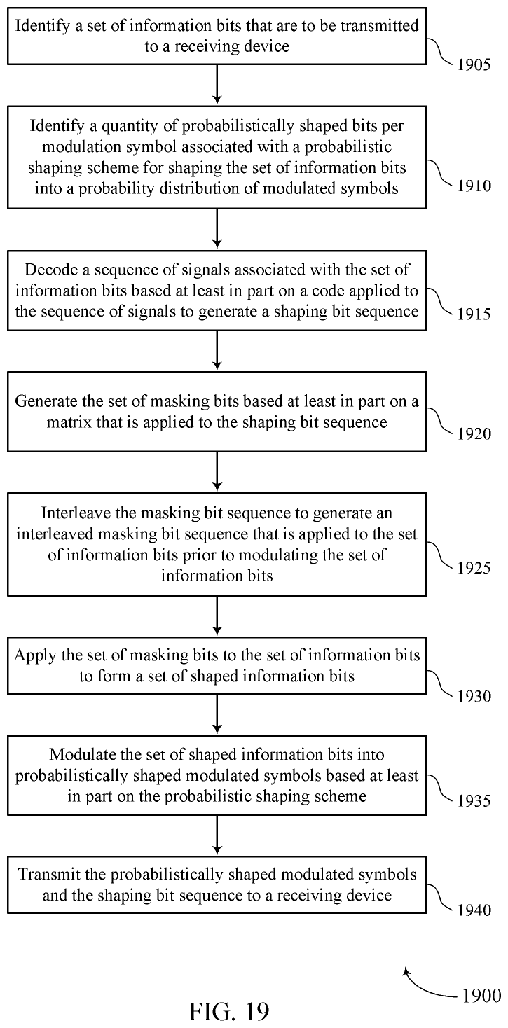

FIG. 19 shows a flowchart illustrating a method 1900 that supports techniques for joint probabilistic shaping of multiple bits per modulation constellation in accordance with one or more aspects of the present disclosure. The operations of the method 1900 may be implemented by a UE or a network entity or its components as described herein. For example, the operations of the method 1900 may be performed by a UE 115 or a network entity as described with reference to FIGS. 1 through 12. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1905, the method may include identifying a set of information bits that are to be transmitted to a receiving device. The operations of 1905 may be performed in accordance with examples as disclosed herein. In some examples, aspects of the operations of 1905 may be performed by a transmission buffer 1025 as described with reference to FIG. 10.

At 1910, the method may include identifying a quantity of probabilistically shaped bits per modulation symbol associated with a probabilistic shaping scheme for shaping the set of information bits into a probability distribution of modulated symbols. The operations of 1910 may be performed in accordance with examples as disclosed herein. In some examples, aspects of the operations of 1910 may be performed by a modulation symbol mapping manager 1030 as described with reference to FIG. 10.

At 1915, the method may include decoding a sequence of signals associated with the set of information bits based on a code applied to the sequence of signals to generate a shaping bit sequence. The operations of 1915 may be performed in accordance with examples as disclosed herein. In some examples, aspects of the operations of 1915 may be performed by a decoder 1055 as described with reference to FIG. 10.

At 1920, the method may include generating the set of masking bits based on a matrix that is applied to the shaping bit sequence. The operations of 1920 may be performed in accordance with examples as disclosed herein. In some examples, aspects of the operations of 1920 may be performed by a masking bit manager 1050 as described with reference to FIG. 10.

At 1925, the method may include interleaving the masking bit sequence to generate an interleaved masking bit sequence that is applied to the set of information bits prior to modulating the set of information bits. The operations of 1925 may be performed in accordance with examples as disclosed herein. In some examples, aspects of the operations of 1925 may be performed by an interleaver 1065 as described with reference to FIG. 10.

At 1930, the method may include applying the set of masking bits to the set of information bits to form a set of shaped information bits. The operations of 1930 may be performed in accordance with examples as disclosed herein. In some examples, aspects of the operations of 1930 may be performed by a masking bit manager 1050 as described with reference to FIG. 10.

At 1935, the method may include modulating the set of shaped information bits into probabilistically shaped modulated symbols based on the probabilistic shaping scheme. The operations of 1935 may be performed in accordance with examples as disclosed herein. In some examples, aspects of the operations of 1935 may be performed by a transmission manager 1045 as described with reference to FIG. 10.

At 1940, the method may include transmitting the probabilistically shaped modulated symbols and the shaping bit sequence to a receiving device. The operations of 1940 may be performed in accordance with examples as disclosed herein. In some examples, aspects of the operations of 1940 may be performed by a transmission manager 1045 as described with reference to FIG. 10.

The following provides an overview of aspects of the present disclosure:

Aspect 1: A method for wireless communication at a transmitting device, comprising: identifying a set of information bits that are to be transmitted to a receiving device; identifying a sequence of signals based at least in part on a modulation function between the set of information bits and a set of modulation symbols; generating, based at least in part on the sequence of signals, a shaping bit sequence, wherein the shaping bit sequence is generated from a decoder of a code applied to the sequence of signals; generating a set of probabilistically shaped modulation symbols based at least in part on the set of information bits and the shaping bit sequence, wherein probabilistic shaping is applied for two or more bits of the set of information bits that are transmitted via the set of probabilistically shaped modulation symbols; and transmitting the set of information bits to the receiving device using the set of probabilistically shaped modulation symbols.

Aspect 2: The method of aspect 1, wherein the sequence of signals is a sequence of real numbers that correspond to a sequence of terms of a mapping function between the set of information bits and the set of modulation symbols.

Aspect 3: The method of any of aspects 1 through 2, wherein the code applied to the sequence of signals is a concatenated code comprising an inner code and an outer code.

Aspect 4: The method of aspect 3, further comprising: determining a set of masking bits based at least in part on a matrix associated with the inner code that is applied to the shaping bit sequence.

Aspect 5: The method of aspect 4, wherein the generating the set of probabilistically shaped modulation symbols comprises: combining the set of masking bits with the set of information bits.

Aspect 6: The method of any of aspects 3 through 5, wherein the shaping bit sequence is generated from decoding the outer code to convert the sequence of signals having a first length into a second sequence of signals of a second length, and decoding the inner code to convert the second sequence of signals of the second length into the shaping bit sequence, and the first length and the second length are associated with a quantity of shaped bits per modulation constellation.

Aspect 7: The method of aspect 6, wherein a masking bit sequence is determined from the shaping bit sequence, the shaping bit sequence is applied to a subset of the set of information bits to generate the set of probabilistically shaped modulation symbols, and the masking bit sequence has the second length.

Aspect 8: The method of any of aspects 1 through 7, further comprising: transmitting the shaping bit sequence to the receiving device with the set of information bits.

Aspect 9: The method of any of aspects 1 through 8, wherein the generating the shaping bit sequence comprises: generating a set of intermediate log likelihood ratios (LLRs) from the sequence of signals based at least in part on an outer code; and decoding the set of intermediate LLRs based at least in part on an inner code to generate the shaping bit sequence.

Aspect 10: The method of any of aspects 1 through 9, further comprising: generating a masking bit sequence from the shaping bit sequence; and interleaving the masking bit sequence to generate an interleaved masking bit sequence that is applied to the set of information bits.

Aspect 11: The method of aspect 10, wherein the interleaving is performed using a triangle interleaver when a polar code is used to generate the shaping bit sequence.

Aspect 12: The method of any of aspects 10 through 11, wherein the interleaving is performed using a systematic bit priority mapping (SBPM) interleaver when a low density parity code (LDPC) is used to generate the shaping bit sequence.

Aspect 13: The method of any of aspects 1 through 12, further comprising: transmitting an indication of a quantity of probabilistically shaped bits per modulation symbol to the receiving device.

Aspect 14: The method of any of aspects 1 through 13, wherein a quantity of probabilistically shaped bits per modulation symbol is a function of a modulation order for communications, is indicated in a modulation and coding scheme (MCS) table, or any combinations thereof.

Aspect 15: The method of any of aspects 1 through 14, wherein the set of probabilistically shaped modulation symbols comprises a first subset of modulation symbols, and a second subset of modulation symbols, and the first subset of modulation symbols includes a first number of bits that are shaped per modulation symbol, and the second subset of modulation symbols includes a second number of bits that are shaped per modulation symbol, and the first number of bits and second number of bits are different.

Aspect 16: A method for wireless communication at a receiving device, comprising: receiving, from a transmitting device, a set of probabilistically shaped modulation symbols that are used to transmit a set of information bits, and a shaping bit sequence, wherein the shaping bit sequence indicates probabilistic shaping that is applied to the set of probabilistically shaped modulation symbols, the probabilistic shaping applied for two or more bits of the set of information bits that are transmitted via the set of probabilistically shaped modulation symbols; determining a set of masking bits based at least in part on the shaping bit sequence and a matrix; applying the set of masking bits to the set of probabilistically shaped modulation symbols to generate an encoded set of information bits; and decoding the encoded set of information bits to determine the set of information bits.

Aspect 17: The method of aspect 16, wherein the set of masking bits are determined as a product of the matrix and the shaping bit sequence.

Aspect 18: The method of any of aspects 16 through 17, wherein the shaping bit sequence is received in a separate set of modulation symbols than the set of probabilistically shaped modulation symbols.

Aspect 19: The method of any of aspects 16 through 18, wherein the set of masking bits and the shaping bit sequence each have an associated length that is based at least in part on a quantity of shaped bits per modulation constellation.

Aspect 20: The method of any of aspects 16 through 19, further comprising: deinterleaving the set of masking bits based on an interleaver associated with communications from the receiving device.

Aspect 21: The method of aspect 20, wherein the deinterleaving is performed using a triangle interleaver when a polar code is used for communications from the receiving device, or using a systematic bit priority mapping (SBPM) interleaver when a low density parity code (LDPC) is used for communications from the receiving device.

Aspect 22: The method of any of aspects 16 through 21, further comprising: receiving an indication of a quantity of probabilistically shaped bits per modulation symbol from the transmitting device.

Aspect 23: A method for wireless communication at a transmitting device, comprising: identifying a set of information bits that are to be transmitted to a receiving device; identifying a quantity of probabilistically shaped bits per modulation symbol associated with a probabilistic shaping scheme for shaping the set of information bits into a probability distribution of modulated symbols; generating a set of masking bits from the set of information bits, wherein the masking bits are determined based at least in part on the quantity of probabilistically shaped bits per modulation symbol; applying the set of masking bits to the set of information bits to form a set of shaped information bits; and modulating the set of shaped information bits into probabilistically shaped modulated symbols based at least in part on the probabilistic shaping scheme.

Aspect 24: The method of aspect 23, wherein the generating the set of masking bits comprises: decoding a sequence of signals associated with the set of information bits based at least in part on a code applied to the sequence of signals to generate a shaping bit sequence; and generating the set of masking bits based at least in part on a matrix that is applied to the shaping bit sequence.

Aspect 25: The method of aspect 24, further comprising: interleaving the masking bits to generate an interleaved masking bit sequence that is applied to the set of information bits prior to modulating the set of information bits.

Aspect 26: The method of aspect 25, wherein the interleaving is performed using a triangle interleaver when a polar code is applied to the sequence of signals.

Aspect 27: The method of any of aspects 25 through 26, wherein the interleaving is performed using a systematic bit priority mapping (SBPM) interleaver when a low density parity code (LDPC) is applied to the sequence of signals.

Aspect 28: The method of any of aspects 24 through 27, further comprising: transmitting the probabilistically shaped modulated symbols and the shaping bit sequence to a receiving device.

Aspect 29: An apparatus for wireless communication at a transmitting device, comprising a processor; memory coupled with the processor; and instructions stored in the memory and executable by the processor to cause the apparatus to perform a method of any of aspects 1 through 15.

Aspect 30: An apparatus for wireless communication at a transmitting device, comprising at least one means for performing a method of any of aspects 1 through 15.

Aspect 31: A non-transitory computer-readable medium storing code for wireless communication at a transmitting device, the code comprising instructions executable by a processor to perform a method of any of aspects 1 through 15.

Aspect 32: An apparatus for wireless communication at a receiving device, comprising a processor; memory coupled with the processor; and instructions stored in the memory and executable by the processor to cause the apparatus to perform a method of any of aspects 16 through 22.

Aspect 33: An apparatus for wireless communication at a receiving device, comprising at least one means for performing a method of any of aspects 16 through 22.

Aspect 34: A non-transitory computer-readable medium storing code for wireless communication at a receiving device, the code comprising instructions executable by a processor to perform a method of any of aspects 16 through 22.

Aspect 35: An apparatus for wireless communication at a transmitting device, comprising a processor; memory coupled with the processor; and instructions stored in the memory and executable by the processor to cause the apparatus to perform a method of any of aspects 23 through 28.

Aspect 36: An apparatus for wireless communication at a transmitting device, comprising at least one means for performing a method of any of aspects 23 through 28.

Aspect 37: A non-transitory computer-readable medium storing code for wireless communication at a transmitting device, the code comprising instructions executable by a processor to perform a method of any of aspects 23 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a transmitting device, comprising:
identifying a set of information bits that are to be transmitted to a receiving device;
identifying a sequence of signals based at least in part on a modulation function between the set of information bits and a set of modulation symbols;
generating, based at least in part on the sequence of signals, a shaping bit sequence, wherein the shaping bit sequence is generated from a decoder of a code applied to the sequence of signals;
generating a set of probabilistically shaped modulation symbols based at least in part on the set of information bits and the shaping bit sequence, wherein probabilistic shaping is applied for two or more bits of the set of information bits that are transmitted via the set of probabilistically shaped modulation symbols; and
transmitting the set of information bits to the receiving device using the set of probabilistically shaped modulation symbols.

2. The method of claim 1, wherein the sequence of signals is a sequence of real numbers that correspond to a sequence of terms of a mapping function between the set of information bits and the set of modulation symbols.

3. The method of claim 1, wherein the code applied to the sequence of signals is a concatenated code comprising an inner code and an outer code.

4. The method of claim 3, further comprising:
determining a set of masking bits based at least in part on a matrix associated with the inner code that is applied to the shaping bit sequence.

5. The method of claim 4, wherein the generating the set of probabilistically shaped modulation symbols comprises:
combining the set of masking bits with the set of information bits.

6. The method of claim 3, wherein the shaping bit sequence is generated from decoding the outer code to convert the sequence of signals having a first length into a second sequence of signals of a second length, and decoding the inner code to convert the second sequence of signals of the second length into the shaping bit sequence, and wherein the first length and the second length are associated with a quantity of shaped bits per modulation constellation.

7. The method of claim 6, wherein a masking bit sequence is determined from the shaping bit sequence, the shaping bit sequence is applied to a subset of the set of information bits to generate the set of probabilistically shaped modulation symbols, and the masking bit sequence has the second length.

8. The method of claim 1, further comprising:
transmitting the shaping bit sequence to the receiving device with the set of information bits.

9. The method of claim 1, wherein the generating the shaping bit sequence comprises:
generating a set of intermediate log likelihood ratios (LLRs) from the sequence of signals based at least in part on an outer code; and
decoding the set of intermediate LLRs based at least in part on an inner code to generate the shaping bit sequence.

10. The method of claim 1, further comprising:
generating a masking bit sequence from the shaping bit sequence; and
interleaving the masking bit sequence to generate an interleaved masking bit sequence that is applied to the set of information bits.

11. The method of claim 10, wherein the interleaving is performed using a triangle interleaver when a polar code is used to generate the shaping bit sequence.

12. The method of claim 10, wherein the interleaving is performed using a systematic bit priority mapping (SBPM) interleaver when a low density parity code (LDPC) is used to generate the shaping bit sequence.

13. The method of claim 1, further comprising:
transmitting an indication of a quantity of probabilistically shaped bits per modulation symbol to the receiving device.

14. The method of claim 1, wherein a quantity of probabilistically shaped bits per modulation symbol:
is a function of a modulation order for communications,
is indicated in a modulation and coding scheme (MCS) table,
or any combinations thereof.

15. The method of claim 1, wherein the set of probabilistically shaped modulation symbols comprises a first subset of modulation symbols, and a second subset of modulation symbols, and wherein the first subset of modulation symbols includes a first number of bits that are shaped per modulation symbol, and the second subset of modulation symbols includes a second number of bits that are shaped per modulation symbol, and the first number of bits and second number of bits are different.

16. A method for wireless communication at a receiving device, comprising:
receiving, from a transmitting device, a set of probabilistically shaped modulation symbols that are used to transmit a set of information bits, and a shaping bit sequence, wherein the shaping bit sequence indicates probabilistic shaping that is applied to the set of probabilistically shaped modulation symbols, the probabilistic shaping applied for two or more bits of the set of information bits that are transmitted via the set of probabilistically shaped modulation symbols;
determining a set of masking bits based at least in part on the shaping bit sequence and a matrix;
applying the set of masking bits to the set of probabilistically shaped modulation symbols to generate an encoded set of information bits; and
decoding the encoded set of information bits to determine the set of information bits.

17. The method of claim 16, wherein the set of masking bits are determined as a product of the matrix and the shaping bit sequence.

18. The method of claim 16, wherein the shaping bit sequence is received in a separate set of modulation symbols than the set of probabilistically shaped modulation symbols.

19. The method of claim 16, wherein the set of masking bits and the shaping bit sequence each have an associated length that is based at least in part on a quantity of shaped bits per modulation constellation.

20. The method of claim 16, further comprising:
deinterleaving the set of masking bits based on an interleaver associated with communications from the receiving device.

21. The method of claim 20, wherein the deinterleaving is performed using a triangle interleaver when a polar code is used for communications from the receiving device, or using a systematic bit priority mapping (SBPM) interleaver when a low density parity code (LDPC) is used for communications from the receiving device.

22. The method of claim 16, further comprising:
receiving an indication of a quantity of probabilistically shaped bits per modulation symbol from the transmitting device.

23. A method for wireless communication at a transmitting device, comprising:
identifying a set of information bits that are to be transmitted to a receiving device;
identifying a quantity of probabilistically shaped bits per modulation symbol associated with a probabilistic shaping scheme for shaping the set of information bits into a probability distribution of modulated symbols;
generating a set of masking bits from the set of information bits, wherein the masking bits are determined based at least in part on the quantity of probabilistically shaped bits per modulation symbol;
applying the set of masking bits to the set of information bits to form a set of shaped information bits; and
modulating the set of shaped information bits into probabilistically shaped modulated symbols based at least in part on the probabilistic shaping scheme.

24. The method of claim 23, wherein the generating the set of masking bits comprises:
decoding a sequence of signals associated with the set of information bits based at least in part on a code applied to the sequence of signals to generate a shaping bit sequence; and
generating the set of masking bits based at least in part on a matrix that is applied to the shaping bit sequence.

25. The method of claim 24, further comprising:
interleaving the masking bits to generate an interleaved masking bit sequence that is applied to the set of information bits prior to modulating the set of information bits.

26. The method of claim 25, wherein the interleaving is performed using a triangle interleaver when a polar code is applied to the sequence of signals.

27. The method of claim 25, wherein the interleaving is performed using a systematic bit priority mapping (SBPM) interleaver when a low density parity code (LDPC) is applied to the sequence of signals.

28. The method of claim 24, further comprising:
transmitting the probabilistically shaped modulated symbols and the shaping bit sequence to a receiving device.

29. An apparatus for wireless communication at a transmitting device, comprising:
a processor;
memory coupled with the processor; and
instructions stored in the memory and executable by the processor to cause the apparatus to:
identify a set of information bits that are to be transmitted to a receiving device;
identify a quantity of probabilistically shaped bits per modulation symbol associated with a probabilistic shaping scheme for shaping the set of information bits into a probability distribution of modulated symbols;
generate a set of masking bits from the set of information bits, wherein the masking bits are determined based at least in part on the quantity of probabilistically shaped bits per modulation symbol;
apply the set of masking bits to the set of information bits to form a set of shaped information bits; and
modulate the set of shaped information bits into probabilistically shaped modulated symbols based at least in part on the probabilistic shaping scheme.

30. The apparatus of claim 29, wherein the instructions to generate the set of masking bits are executable by the processor to cause the apparatus to:
decode a sequence of signals associated with the set of information bits based at least in part on a code applied to the sequence of signals to generate a shaping bit sequence;
generate the set of masking bits based at least in part on a matrix that is applied to the shaping bit sequence; and
interleave the masking bits to generate an interleaved masking bit sequence that is applied to the set of information bits prior to modulating the set of information bits.
